(19) United States
(12) Patent Application Publication
(10) Pub. No.: US 2012/0078509 A1
(43) Pub. Date: Mar. 29, 2012

(54) Intelligent Navigation For A Motor Vehicle

(75) Inventor: Dave Choi, Marysville, OH (US)

(73) Assignee: Honda Motor Co., Ltd, Tokyo (JP)

(21) Appl. No.: 12/891,035

(22) Filed: Sep. 27, 2010

(51) Int. Cl. G01C 21/36; G01C 21/00; G06F 7/00

(52) U.S. Cl. 701/423; 701/419

(57) ABSTRACT

Methods of controlling a motor vehicle include detecting an unsafe condition. Unsafe conditions can be driver conditions, vehicle conditions as well as external conditions. The method further includes finding a safe area and automatically determining a route to the safe area. A driver can be notified of the route to the safe area.

### BACKGROUND

The present invention relates generally to motor vehicles, and in particular to vehicle navigation systems and methods for automatically generating routing instructions in response to a detected unsafe condition.

Driving is an inherently hazardous activity. Many factors contribute to these inherent hazards. In some instances, the driver's own behavior can pose a hazard. Drivers have an ever increasing access to electronic devices. These may include devices that are part of the vehicle and also to portable devices that are brought into the vehicle. If a driver attempts to use one or more of these devices while driving, the driver can be distracted to such an extent that an accident may occur.

For example, a driver may fix his or her gaze on a device such as a cell phone while using the device and fail to notice conditions on the road. Prolonged gaze fixation may also occur if a driver attempts to change a vehicle instrument setting while the vehicle is moving.

The condition of the driver can also create a dangerous driving condition. The vehicle operator may be under the influence of drugs or alcohol, for example, to such an extent that his or her driving ability is impaired. A driver may also become drowsy while driving or may become agitated to a degree that the driver can no longer safely operate the vehicle and stop driving.

The vehicle itself may malfunction or become damaged while the driver is operating the vehicle. Damage to the vehicle or a vehicle malfunction may pose a danger to the vehicle occupants or may pose a risk of serious and expensive damage to the vehicle if the driver continues to operate the vehicle. If a tire is punctured, for instance, tire pressure may decrease at a rate that the soft tire may cause loss of control of the vehicle and an accident. A fluid level in the vehicle may drop to such a level that continued operation of the vehicle for a prolonged period of time may seriously damage the vehicle.

Driving can also become more difficult or dangerous if the driving environment changes. Driving a particular route generally becomes more dangerous when the amount of traffic on the road increases. The weather may become worse while the driver is operating the vehicle. An accident may occur which temporarily stops or restricts traffic flow around the accident. These environmental conditions may also occur together. For instance bad weather may slow traffic resulting in increased traffic congestion and the increased likelihood of vehicle accidents.

### SUMMARY

In one aspect, a method of using a control unit to provide a vehicle driver with routing instructions to a safe area when an unsafe condition is detected includes receiving data indicating the existence of the unsafe condition from a data source in communication with the control unit and selecting the safe area. The method also includes automatically generating routing instructions to the safe area in response to the receiving data indicating the existence of the unsafe condition and notifying the vehicle driver through the use of an output device in communication with the control unit of the existence of the unsafe condition and of the availability of routing instructions to the safe area. The method also includes communicating the routing instructions to the driver in response to the actuation of an input device in communication with the control unit.

In another aspect, a method of using a control unit to provide a vehicle driver with routing instructions to a safe area when the existence of an unsafe condition is detected includes receiving data indicating the existence of the unsafe condition from a data source in communication with the control unit and notifying the vehicle driver through the use of an output device in communication with the control unit of the existence of the unsafe condition. The method also include automatically querying the driver in response to the existence of the unsafe condition to determine if the driver would like routing instructions to the safe area. The method also includes receiving an input from the driver through the use of an input device in communication with the control unit requesting routing instructions to the safe area, selecting the safe area and generating routing instructions to the safe area in response to said receiving an input indicating the request for routing instructions and communicating the routing instructions to the driver.

In another aspect, a control system configured to provide a vehicle driver with routing instructions to a safe area when data is received from a data source indicating the existence of an unsafe condition includes a control unit comprising a processing unit and a data storage unit that is in communication with said processing unit, where the data storage unit is configured to have a collection of data resident therein. The control system also includes an output device in communication with the control unit and capable of communicating with the driver and an input device in communication with the control unit that is configured to receive an input from the driver and to send data to the control unit in response to the driver input. The control system also includes an input port in communication with the control unit and with the data source, the input port being configured to send data received from the data source to the control unit and where the control unit is programmed to receive data from the data source indicating the existence of an unsafe condition, calculate routing instructions to the safe location and communicate the routing instructions to the driver using the output device.

In another aspect, a method of selecting a safe area for a motor vehicle includes detecting an unsafe condition. The method also includes receiving the location of the motor vehicle, retrieving a predetermined time and retrieving a plurality of points of interest. The method also includes selecting at least one of the plurality of points of interest that can be reached by the vehicle within the predetermined time. The method also includes using the at least one of the plurality of points of interest as a safe area and automatically providing routing instructions to the safe area.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

Embodiments of the invention can be better understood with reference to the following drawings and description. The components in the figures are not necessarily to scale, emphasis instead being placed upon illustrating the principles of embodiments of the invention. Moreover, in the figures, like reference numerals designate corresponding parts throughout the different views.

FIG. 1 is a perspective view of an embodiment of a motor vehicle that shows a schematic representation of a vehicle engine in phantom and a schematic representation of a navigation system in phantom;

FIG. 2 is a schematic view of an embodiment of a portion of the vehicle of FIG. 1 and of an example embodiment of a control system associated with a motor vehicle;

FIG. 3 is view of an embodiment of an interior portion of a passenger cabin of the motor vehicle of FIG. 1;

FIG. 4 is a view of an embodiment of an output device for the control system showing a screen display that may be used to query a vehicle driver to determine if routing instructions are requested;

FIG. 5 is a view of the output device of FIG. 4 showing a screen display that may be used to query a vehicle driver to determine if the driver would like routing instructions displayed in a graphic or a text format;

FIG. 6 is a view of the output device of FIG. 4 showing a screen display of routing instructions displayed in a graphic format;

FIG. 7 is a view of the output device of FIG. 4 showing a screen display of routing instructions displayed in a text format;

FIG. 8 is an embodiment of a process that may be carried out by a control system for monitoring for an unsafe condition and for generating routing instructions when an unsafe condition is detected;

FIG. 9 is an embodiment of a process that may be carried out by a control system for monitoring for an unsafe condition and for generating routing instructions when an unsafe condition is detected;

FIG. 10 is an embodiment of a process that may be carried out by a control system to determine a format for providing routing instructions to a driver depending on whether or not a safe area can be reached within a predetermined amount of time;

FIG. 11 is a schematic view of an embodiment of a method of selecting a safe area from a plurality of points of interest;

FIG. 12 is an embodiment of a process for selecting a safe area from a plurality of points of interest;

FIG. 13 is an embodiment of a process that may be carried out by a control system to determine whether or not a driver has at least a predetermined amount of time available to execute a routing instruction;

FIG. 14 is an embodiment of a process that may be carried out by a control system to determine whether or not a safe area should be selected from a particular category;

FIG. 15 is an embodiment of a process that may be carried out by a control system if a driver's alcohol level is above a predetermined threshold;

FIG. 16 is an embodiment of a process that may be carried out by a control system if a driver becomes drowsy;

FIG. 17 is an embodiment of a process that may be carried out by a control system if a problem with the vehicle is detected;

FIG. 18 is an embodiment of a process that may be carried out by a control system if the system detects that a driver is engaged in data entry while driving;

FIG. 19 is an embodiment of a process that may be carried out by a control system if the system detects that the vehicle is heading into a dangerous weather condition; and

FIG. 20 is an embodiment of a process that may be carried out by a control system if the system detects that the vehicle is heading into an area of congested traffic.

### DETAILED DESCRIPTION

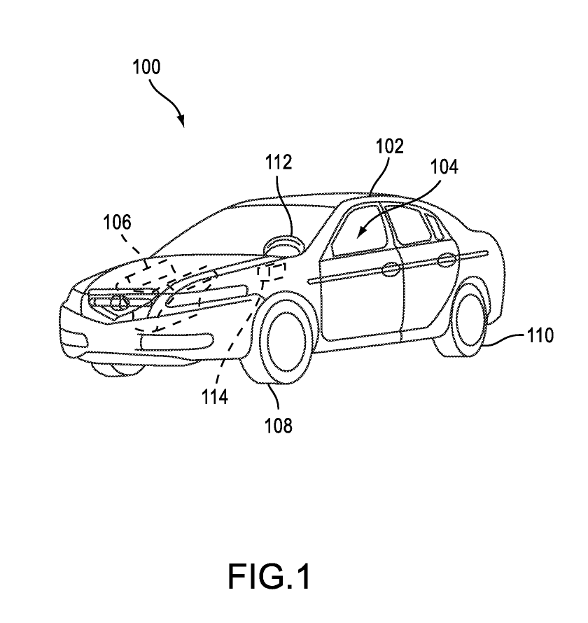

FIG. 1 is an isometric view of an embodiment of a motor vehicle 100. The term “motor vehicle” as used throughout this detailed description and in the claims refers to any moving vehicle that is capable of carrying one or more human occupants and is powered by any form of energy. The term “motor vehicle” includes, but is not limited to: cars, trucks, vans, minivans, SUVs, motorcycles, scooters, boats, personal watercraft, and aircraft.

In some cases, the motor vehicle includes one or more engines. The term “engine” as used throughout the specification and claims refers to any device or machine that is capable of converting energy. In some cases, potential energy is converted to kinetic energy. For example, energy conversion can include a situation where the chemical potential energy of a fuel or fuel cell is converted into rotational kinetic energy or where electrical potential energy is converted into rotational kinetic energy. Engines can also include provisions for converting kinetic energy into potential energy. For example, some engines include regenerative braking systems where kinetic energy from a drive train is converted into potential energy. Engines can also include devices that convert solar or nuclear energy into another form of energy. Some examples of engines include, but are not limited to: internal combustion engines, electric motors, solar energy converters, turbines, nuclear power plants, and hybrid systems that combine two or more different types of energy conversion processes.

For purposes of clarity, only some components of the motor vehicle 100 are shown in the current embodiment. Furthermore, it will be understood that in other embodiments some of the components may be optional. Additionally, it will be understood that in other embodiments, any other arrangements of the components illustrated here can be used for powering the motor vehicle 100.

The motor vehicle 100 includes an automobile body 102 that provides a passenger compartment 104. An engine 106 (shown schematically) is mounted within the automobile body 102. The motor vehicle 100 includes a pair of ground engaging front wheels 108 and a pair of rear wheels 110 mounted for rotational movement on automobile body 102. At least one of the front wheels 108 and/or rear wheels 110 is operatively coupled to the engine 106 so that power from the engine 106 is capable of rotating the wheels to move the motor vehicle 100. A steering wheel 112 is mounted in the passenger compartment 104 and is operatively coupled to the front wheels 108 to steer the motor vehicle 100. The motor vehicle 100 includes a navigation system 114 (shown schematically).

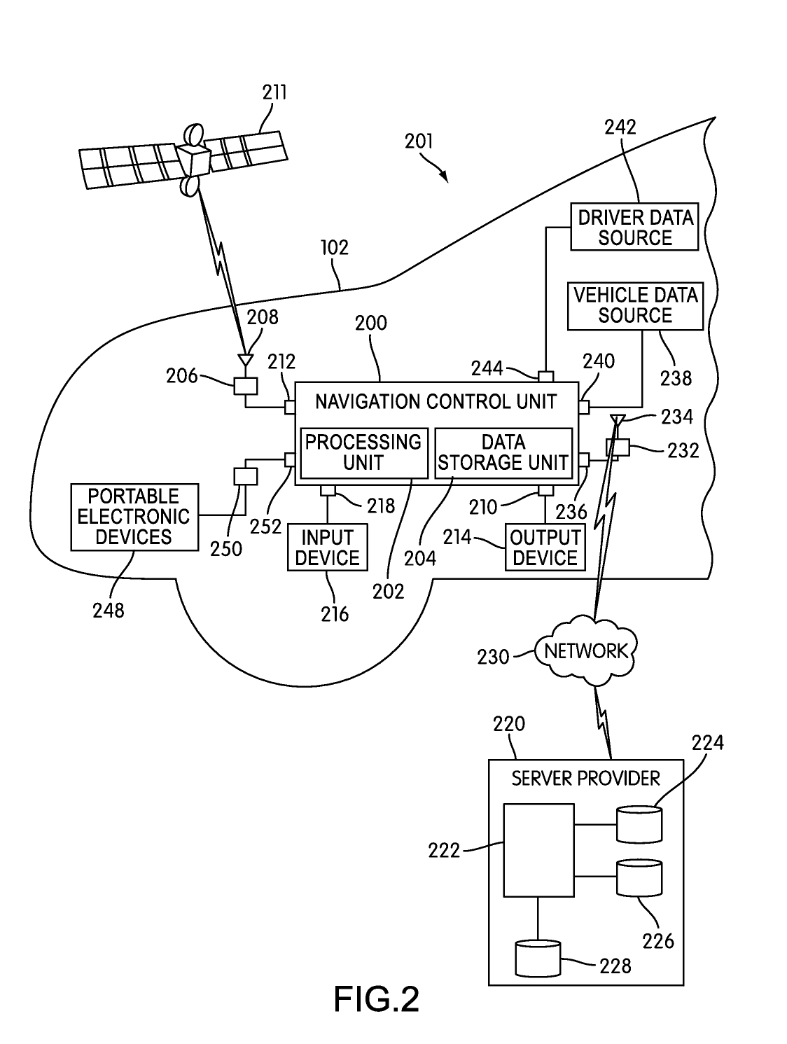

FIG. 2 is a schematic view of an example embodiment of a control system 201 that may be used with motor vehicle 100. In some embodiments, control system 201 may be associated with navigation system 114 (see FIG. 1). In some cases, control system 201 may comprise navigation system 114. In other cases, however, control system 201 may comprise various different components that communicate with navigation system 114 as well as other systems of the motor vehicle 100.

A control system can include provisions for operating one or more systems of the motor vehicle 100 in response to driver behavior, vehicle operating conditions and/or external conditions. In some embodiments, the control system 201 may function to receive data indicating the existence of a condition that requires the driver's attention from a data source in communication with the control system 201. These conditions may include an unsafe condition related to the vehicle itself, an unsafe condition or behavior of the driver, or some other unsafe condition. These conditions may also be related to the driving environment such as the traffic, road conditions or the weather the driver is facing. A driver facing certain conditions may, once informed of the condition, wish to be directed to an area where the detected condition can best be dealt with. Such an area may be referred to as a “safe area”. The control system 201 may, in response the detection of a condition, operate to automatically generate routing instructions to a safe area, to notify the vehicle driver of the existence of the condition and of the availability of routing instructions to the safe area and communicate the routing instructions to the driver if the driver so desires.

The term “safe area” as used throughout this detailed description and in the claims refers to any location where a vehicle can stop in order to reduce any risks posed by the detected condition. In the present specification and claims, the term “safe area” can be used to designate a wide range of areas. In some instances (e.g., the driver wants to use a cell phone), a safe area may be any area where the driver can safely stop the vehicle and deal with the task at hand (e.g., complete the call). Examples of such an area include, but are not limited to, parking lots, commercial and retail areas that include parking for patrons (e.g., retail stores, hotels, restaurants, and the like), service stations, various public facilities (e.g., parks, municipal parking lots, highway rest stops, municipal and other public buildings), the curbside of a street where street parking is allowed, the shoulder of a road, or anywhere else that would provide a place for a vehicle to stop temporarily.

In some embodiments, the control system 201 can include provisions for monitoring and/or controlling various devices, components and/or systems of the motor vehicle 100. In one embodiment, the control system 201 may include a control unit 200. In some embodiments, control unit 200 may be an electronic control unit. In other embodiments, control unit 200 could be any other type of control unit. In some embodiments, control unit 200 includes a processing unit 202 and a data storage unit 204. The processing unit 202 may comprise a computer processor. The data storage unit 204 may include one or more kinds of storage components or devices such as one or more types of computer memory or one or more types of computer disk drive or both. Examples of disk drives may include magnetic, optical and magneto-optical drives. Examples of computer memory may include volatile memory and non-volatile memory, random access memory (RAM) and read-only memory (ROM). The data storage unit 204 is in electronic communication with the processing unit 202. The data storage unit 204 may be configured to have a collection of data resident therein. This data may comprise a wide range of data including navigation data or navigation information (the terms “navigation data” and “navigation information” are used interchangeably herein).

Although the current embodiment shows data storage unit 204 integrated with control unit 200, in other embodiments, data storage unit 204 could be an external storage unit. For example, in other embodiments, data storage unit 204 could be an external database that is in communication with control unit 200. In still another embodiment, data storage unit 204 could comprise multiple external databases. In still other embodiments, data storage unit 204 could comprise an internal storage unit as well as an external storage unit, with respect to control unit 200.

“Navigation data” may refer to any data or information that can be used, for example, to assist in determining one or more locations, in determining various routes to these locations and information about areas surrounding a particular location or route. The navigation data may include map related data. Examples of map data include street addresses, street names, street or address numbers, apartment or suite numbers, intersection information, political or geographical subdivision information including town, township, province, prefecture, city, state, district, ZIP or postal code, and country information. The map data may also include information about various streets, roads, and highways such as whether a road is single lane or multi-lane, one-way or bi-directional, paved or not paved, whether a road (or particular lane on a road) has high occupancy vehicle (HOV) restrictions or not and at what times, and whether a road is a toll road or not. Navigation data may also include geographical or topological information about an area (e.g., whether a particular route to a given location is relatively flat or relatively hilly in relation, for example, to an alternate route to the given location).

Navigation data may also include information about various points of interest (POI's). This POI data includes a wide range of information. Examples of POI data is information related to any businesses open to the public and government facilities in the vicinity of a particular location or along a particular route. Businesses may include restaurants, retail stores, hotels, parking facilities, medical facilities, gas stations, vehicle repair facilities as well as other types of information. The information about these POI's may include business location, products, services and amenities offered, prices, hours of operation as well as other types of information. Government facilities may include police stations, fire departments, ambulance services, post offices, libraries, health facilities, and any other public facilities. The information about these public facility POI's may include location, services offered, hours of operation as well as other types of information.

The navigation data may be included in a navigation database that is resident in the data storage unit 204. The navigation database may categorize the POI's by type. For example, businesses and government facilities may be categorized by type. Categories may include restaurants, gas (or “service”) stations, vehicle repair facilities, medical clinics, hospitals, hotels, pharmacies, emergency rooms, law enforcement and so on. Some of businesses and government facilities may be included in more than category. For example, a gas station that offers vehicle repair services may be included in the gas station category and the vehicle repair facility category.

In some embodiments, control unit 200 may be used solely in conjunction with a navigation system of the motor vehicle 100. In other words, in some cases, a navigation system may have a dedicated control unit, including a processor. In other embodiments, however, control unit 200 may be shared by various different systems of the motor vehicle 100. For example, in some situations, control unit 200 may be used to process navigation information, while in other situations control unit 200 may function to process other kinds of information necessary for operating various different subsystems of the motor vehicle 100. For purposes of clarity, only the components related to the operation of control system 201 are shown in the current embodiment. However, in other embodiments, additional components or systems may be in communication with control unit 200.

Control unit 200 may include a number of ports that facilitate the input and output of information and power. The term “port” as used throughout this detailed description and in the claims refers to any interface or shared boundary between two conductors. In some cases, ports can facilitate the insertion and removal of conductors. Examples of these types of ports include mechanical connectors. In other cases, ports are interfaces that generally do not provide easy insertion or removal. Examples of these types of ports include soldering or electron traces on circuit boards. Alternatively, some ports could represent wireless connections.

All of the following ports and provisions associated with control unit 200 are optional. Some embodiments may include a given port or provision, while others may exclude it. The following description discloses many of the possible ports and provisions that can be used, however, it should be kept in mind that not every port or provision must be used or included in a given embodiment.

Control unit 200 may include provisions for receiving Global Positioning Satellite (hereafter “GPS”) information. In some cases, control system 201 may include GPS receiver 206 and a GPS antenna 208. GPS antenna 208 is configured to receive satellite signals from a network of GPS satellites 211 (represented by a single satellite for convenience) and transmit received signals to the GPS receiver 206. The GPS receiver 206 is in electrical communication with the control unit 200 through port 212. The GPS receiver 206 is configured to determine navigation information about the motor vehicle 100 from the received GPS signals including, but not limited to, the location, heading and speed of the motor vehicle 100 continuously or at intervals as the vehicle is being driven. Using this GPS information, the control system 201 may be configured to automatically determine a beginning point for a particular route as well as to track the position and speed of motor vehicle 100 along the route.

The GPS receiver 206 may be configured to obtain navigation information from any Global Navigational Satellite System (GNSS), including Global Positioning System or Satellite (GPS), Glonass (Russian) and/or Galileo (European). The term “GPS” is used herein to denote any global navigational satellite system. Navigation information can include one item of information or a combination of several items of information.

Generally, any navigation system and navigation information known in the art can be used. One example of a navigation system is disclosed in Furukawa, U.S. Pat. No. ______, now U.S. Patent Application Publication Number 2005/0261827, filed on May 19, 2004, the entirety of which is hereby incorporated by reference. Another example of a navigation system is disclosed in Shishido, U.S. Pat. No. 5,842,146, filed on May 10, 1996, the entirety of which is hereby incorporated by reference.

Control unit 200 may include provisions for communicating with a vehicle driver. The example control system 201 includes output device 214 and input device 216. Output device 214 is in electrical communication with the control unit 200 through port 210 and input device 216 is in electrical communication with the control unit 200 through port 218.

Output device 214 is a schematic representation of one or more devices that may be used to communicate information from the control system 201 to the driver. Output device 214 may include devices that communicate with the driver audibly or visually. More specifically, the output device 214 can include a display screen capable of displaying graphic information (e.g., maps which include vehicle location and route information) and/or in text format. The output device 214 may also include one or more loudspeakers that communicate audio to the driver (e.g., audible turn-by-turn directions). The speakers may be part of the vehicle's audio system or they may be incorporated into a wired or wireless headset.

The input device 216 is in communication with the control unit 200 and is configured to receive an input from a driver (or other vehicle occupant) and to send data to the control unit 200 in response to the driver input. The input device 216 in the present example embodiment is a schematic representation of one or more devices that may be used to communicate information from the driver (or any other vehicle occupant) to the control system 201. The input device 216 may include devices that allow a person to communicate with the control system 201 audibly or manually. More specifically, manual input devices include keyboards (wired or wireless), and/or a mouse or other pointing device (if, for example, the control system 201 includes a display screen that provides a graphical user interface), and/or a touch screen, and/or one or more buttons that allow a driver to input destinations for determining routes.

In some embodiments, the control system 201 may be in communication with a service provider 220. The term “service provider” may refer to any collection of computing resources and/or databases that are disposed outside the motor vehicle 100 and which are capable of collecting, storing and processing information and of communicating with the control system 201 of the motor vehicle 100. Service provider 220 may be a collection of networked computers or computer servers. Service provider 220 may be used to receive, process and/or store information of any kind. In some instances, service provider 220 may be configured to collect information related to traffic on roadways, process the information and store the information for later use. In addition, service provider 220 may be configured to calculate routes for control system 201, which may function as a navigation system in some contexts.

Service provider 220 may include a computer system 222. The term “computer system” may refer to the computing resources of a single computer, a portion of the computing resources of a single computer, and/or two or more computers in communication with one another. Any of these resources may be operated by one or more human users. In some cases, computer system 222 may include a server.

The service provider 220 may store various types of information and may include one or more databases. For example, the service provider 220 may include a database 224 for storing navigation information, a database 226 for storing traffic information, and/or a database 228 for storing weather information. The traffic data base 226 include any information related to the speed of one or more vehicles on a roadway, the number of vehicles on a roadway, the presence of construction on a roadway, traffic accidents on a roadway and similar information. Traffic information may refer to either real-time traffic information or historic traffic information.

The control system 201 may include provisions for communicating with the service provider 220. In the example embodiment, the control system 201 communicates with the service provider 220 using network 230. Network 230 may be any type of network. For example, network 230 may be a vehicle communication network that uses motor vehicles for at least some nodes of the network. Network 230 may also include roadside units as nodes. Vehicle communication networks may be used for exchanging various types of information between motor vehicles and/or roadside units. An example of such a network is a dedicated short range communication (DSRC) network. The control system 201 may additionally or alternatively configured to communicate with the service provider 220 using any other type of wireless network, including, but not limited to WiFi networks and cell phone networks. Network 230 may be associated with any type of network standard including, but not limited to: CDMA, TDMA, GSM, AMPS, PCS, analog and/or W-CDMA.

In one embodiment, the control system 201 includes a network transmitter and receiver 232 that is coupled to network antenna 234. The network transmitter and receiver 232 is in electrical communication with the control unit 200 through port 236. The control system 201 in the example embodiment is capable of communication with the service provider 220 utilizing the network transmitter and receiver 232 and the network antenna 234 through network 230.

The control system 201 may be in electrical communication with one or more sensors or monitoring devices that monitor components or systems of the motor vehicle 100. Each monitor or sensor operates as a data source so that the control system 201 can receive information indicating whether or not the vehicle is operating properly. More specifically, in the example embodiment, the control unit 200 is in electrical communication with a vehicle data source 238 through port 240. The vehicle data source 238 is represented schematically in FIG. 2 and indicates the presence on the motor vehicle 100 of one or more sensors or monitors on the vehicle 100 that monitor various conditions, systems or devices of the motor vehicle 100 and are operable to send data to the control system 201 in the event a hazardous or other predefined event occurs.

For example, the vehicle data source 238 may include one or more devices that monitor a vehicle fluid level (for example, fuel level, engine oil level, transmission fluid level, brake fluid level, etc.), a vehicle fluid pressure (for example, tire pressure), or a vehicle temperature (for example, engine temperature). The vehicle data source 238 may also include a one or more devices that monitor various systems of the vehicle 100 including one or more components of the vehicle electrical system (for example, battery operation, functioning and operation of one or more dashboard warning lights, functioning and operation of all exterior vehicle lights such as headlights, turn signals, brake lights, and so on), the vehicle brake system (for example brake pad levels) and the vehicle emissions system (for example, oxygen sensors, etc.). In some cases, the vehicle data source 238 may also be configured to monitor operating parameters including vehicle speed, engine speed, yaw rate, lateral accelerations as well as other parameters.

The control system 201 may be in electrical communication with one or more sensors or monitoring devices that monitor the driver (and/or any other vehicle occupants). It will be understood that although these devices and the methods of using them are discussed with reference to the driver, this is done for convenience only. The methods described can be applied to any other occupant of the vehicle where appropriate. In the example embodiment, the control unit 200 is in electrical communication with a driver data source 242 through port 244. The driver data source 242 is represented schematically in FIG. 2 and indicates the presence of one or more sensors or monitors that monitor the driver in some way. Each monitor or sensor operates as a data source so that the control system 201 can receive information regarding some aspect of the driver or conditions of the driver. Each sensor comprising the driver data source 242 is operable as a data source that can send data to the control system 201 in the event a hazardous or other predefined condition or event related to the driver occurs.

For example, the driver data source 242 may include one or more devices that monitor the alcohol level of the driver (for example, the amount of alcohol in the driver's breath, the driver's sweat, etc.). Alcohol monitoring devices are disclosed in Sofer, U.S. Pat. No. 7,671,752, filed Feb. 13, 2006, the entirety of which is hereby incorporated by reference. Further examples are disclosed in Brown et al., U.S. Pat. No. 7,413,047, filed Mar. 25, 2005, the entirety of which is hereby incorporated by reference. It will be understood that any other kinds of alcohol monitoring devices known in the art could be used.

The driver data source 242 may also (or alternatively) include devices that monitor the driver to determine if the driver is getting drowsy or falling asleep. Driver sleep detection devices are disclosed in Clarke, Sr. et al., U.S. Pat. No. 5,689,241, filed May 31, 1996, the entirety of which is hereby incorporated by reference. Further examples are disclosed in D'Agosto, U.S. Pat. No. 6,590,499, filed Feb. 4, 2002, the entirety of which is hereby incorporated by reference. It will be understood that any other kinds of sleep or drowsiness detection devices known in the art could be used.

The driver data source 242 may also (or alternatively) comprise devices that monitor the driver to determine if the driver is agitated or upset. Such devices could detect visual information, audible information or tactile information for determining if a driver is agitated or upset. Moreover, driver data source 242 could also comprise devices for detecting other emotional states of a driver. It will be understood that any devices known in the art for detecting the emotions of a user could be used.

The driver data source 242 may further comprise any device that can be used to monitor any aspect of the health or behavior of the driver. Examples include but are not limited to a heart rate monitor and a blood glucose monitor.

The control system 201 may also include the capability of detecting, communicating with and controlling certain portable electronic devices 248 that are brought into the vehicle 100 through the use of a portable electronic device controller 250. The portable electronic device controller 250 is in electrical communication with the control unit 200 through port 252 and is capable of being in electrical communication with portable electronic devices 248. Examples of these portable electronic devices include cell phones, Smart Phones®, portable and laptop computers, Blackberry® devices and similar devices. In instances in which a portable electronic device controller 250 is associated with the control system 201, the portable electronic device controller 250 may also be configured to communicate with each portable electronic device in the vehicle 100 wirelessly. The Bluetooth protocol may be used for this wireless communication as well as any other wireless protocol. In other cases, any type of personal area network can be used, including any personal area network protocols.

It will be understood that in some cases, control unit 200 may also be in communication with various onboard or integrate vehicle electronic devices. Examples of these devices include, but are not limited to: DVD players, radios, CD players, MP3 players, video game systems, entertainment devices as well as other kinds of vehicle electronic devices. The term vehicle electronic devices can also refer to any electronic devices used to control various electrical systems such as power doors, power windows, temperature control, moon or sun roofs as well as other systems.

For purposes of clarity, the various components of control system 201 are shown schematically in the embodiments. It will be understood that the various components or devices could be distributed throughout motor vehicle 100. Moreover, in some cases, some of these devices could be disposed outside of the motor vehicle 100.

It will be understood that in some embodiments, navigation information could be stored on board of a motor vehicle. Moreover, in some cases, a navigation system located within the motor vehicle could be used to calculate various routes or other information to provide to a driver or occupant. In other embodiments, however, navigation information could be stored and/or processed remotely, such as at a service provider. In these other embodiments, a control unit may send a request for navigation information including routes to a particular destination. The service provider may process the request and send the requested navigation information back to the control unit where it may be provided to a driver or occupant. An example of a system where navigation information can be stored and/or processed remotely is disclosed in Furukawa, U.S. Pat. No. ______, now U.S. patent application Ser. No. 10/848,508, filed May 19, 2004, the entirety of which is hereby incorporated by reference.

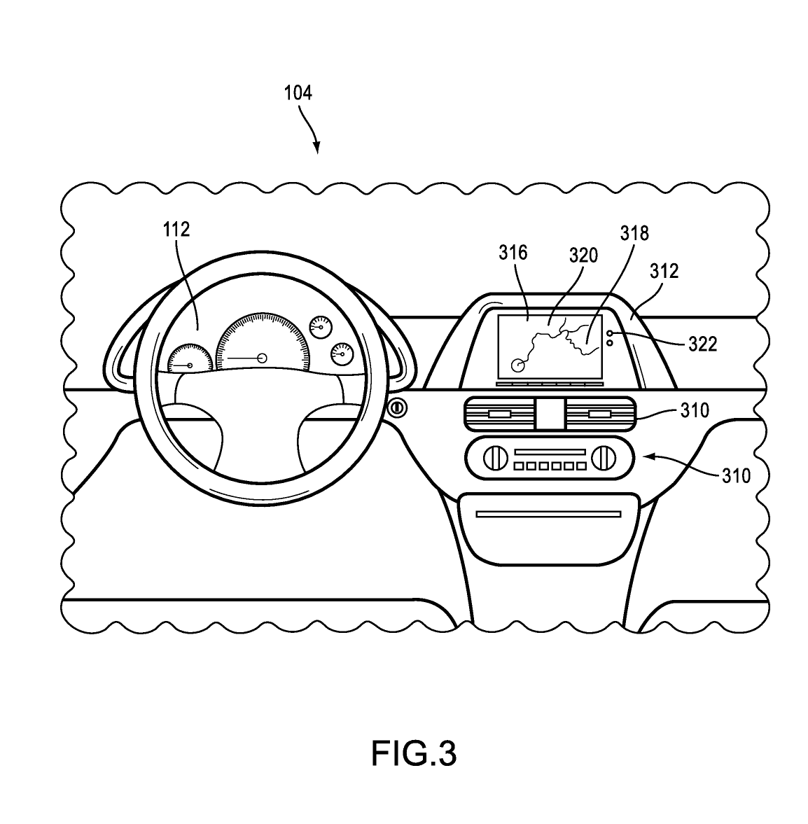

FIG. 3 is an example embodiment of an interior portion of the passenger compartment 104 of the motor vehicle 100 of FIG. 1. The interior includes the steering wheel 112, a dashboard 308 and center console 310. The center console 310 includes an upper portion 312 and a lower portion 314. In some embodiments, lower portion 314 includes radio and/or audio controls. In the example embodiment, the upper portion 312 of the center console 310 includes a touch screen display 316. The touch screen display 316 includes an underlying display screen portion 318 and an overlying touch sensitive portion 320. The display screen portion 318 functions as an output device capable of displaying text and graphics to the occupants of the passenger compartment 104. The touch sensitive portion 320 functions as an input device by enabling a person to input data and responses in the control system 201 by depressing various areas of the screen in succession. The touch screen display 316 includes a series of buttons 322 which also function as input devices of the control system 201.

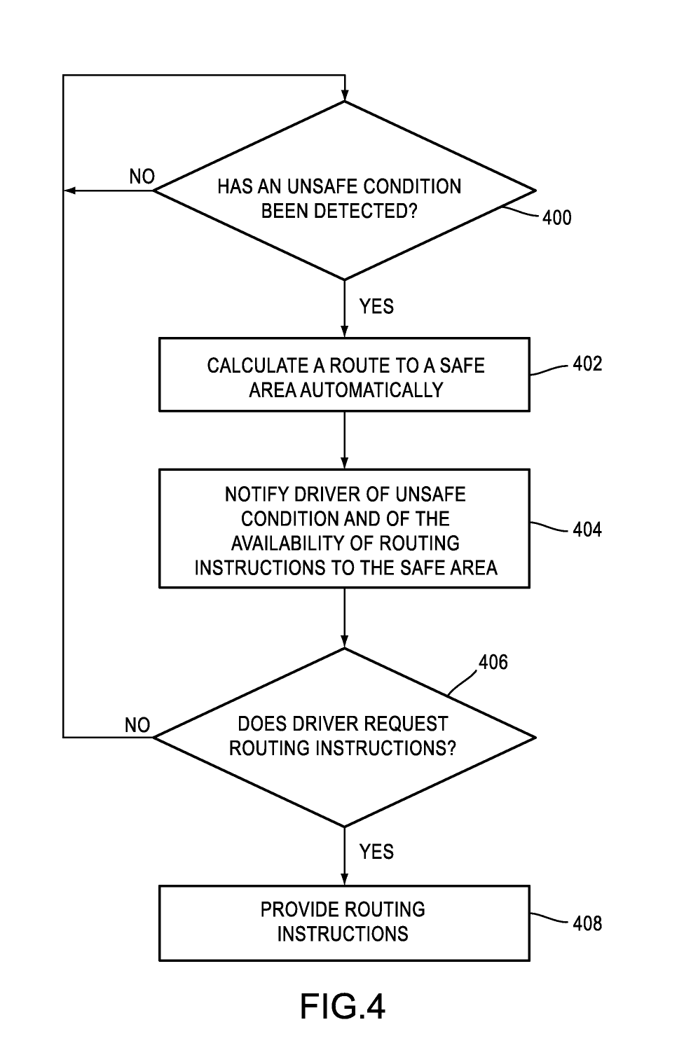

The control system 201 can be used to carry out a great many processes and methods that can make driving easier and safer. An example of a method of using the control system 201 (including the navigation system 114) to detect and respond to an unsafe condition is illustrated in FIG. 4. FIG. 4 illustrates an example of a method for providing a vehicle driver with routing instructions to a safe area automatically when an unsafe condition is detected. In some embodiments, some of the following steps could be accomplished by a control system of a motor vehicle. In some cases, some of the following steps may be accomplished by a control unit of a motor vehicle. In other embodiments, some of the following steps could be accomplished by other components of a motor vehicle. It will be understood that in other embodiments one or more of the following steps may be optional.

At step 400 the control system 201 (see FIG. 2) monitors information from various input devices to detect an unsafe condition. If no unsafe condition is detected, the control system 201 returns to step 400. In some cases, the process is continuously repeated until an unsafe condition is detected. If an unsafe condition is detected at step 400, the method automatically selects a safe area and calculates a route to the safe area at step 402. Generally, any method of selecting a safe area can be used. Methods for selecting a safe area are discussed in further detail below.

The control system 201 may detect an unsafe condition by continuously receiving data from one or more data sources indicating the existence of an unsafe condition. These data sources may include a vehicle data source 238, a driver related data source 242, the service provider 220 (weather and/or traffic information, for example), the one or more input devices 216 and the portable electronic devices 248 through data received from the portable electronic device controller 250 (see FIG. 2). In other cases, unsafe conditions may be detected by any other components, devices, sensors or systems.

When the control system 201 automatically calculates a route to a safe area in step 402, this step may include the steps of selecting a safe area and then automatically generating routing instructions to the selected safe area in response to receiving data indicating the existence of the unsafe condition. In some cases, the control system 201 notifies the driver through the use of an output device in communication with control unit 200 of existence of the unsafe condition and of the availability of routing instructions to the safe area at step 404. The driver may be queried at step 406 to determine whether or not the driver wants to receive the routing instructions to guide the vehicle 100 to the selected safe area or not. If the driver does not want routing instructions, the control system 201 may return to step 400. If the driver elects to go to the safe area, the control system 201 provides step-by-step routing instructions at step 408.

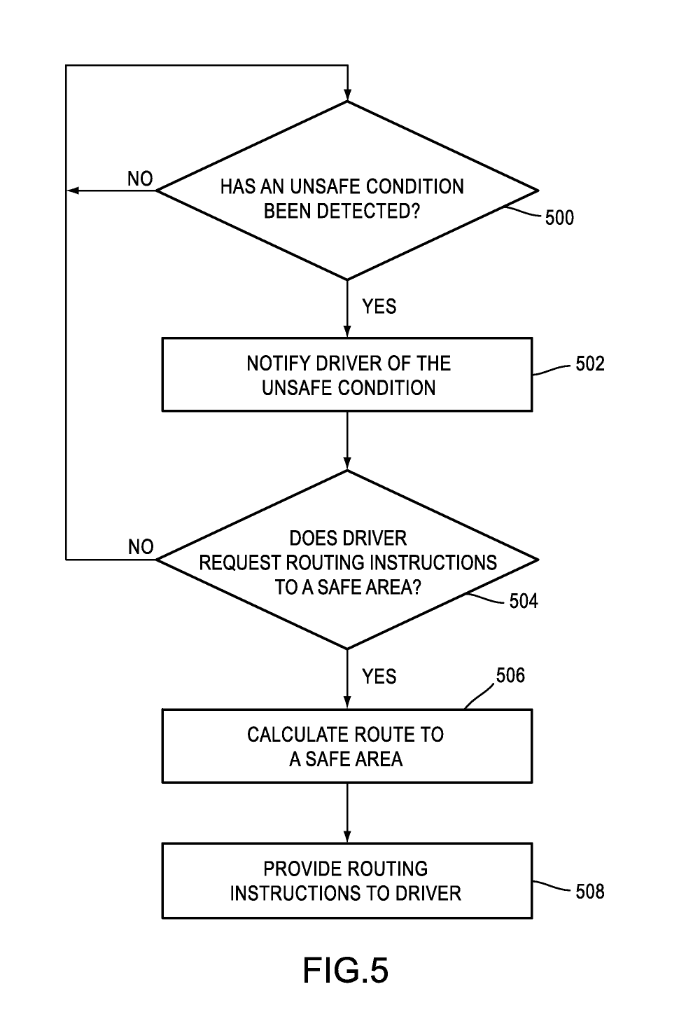

FIG. 5 shows another example of a method for providing a vehicle driver with routing instructions to a safe area when the existence of an unsafe condition is detected. At step 500 the control system 201 monitors information from various input devices to detect an unsafe condition. If no unsafe condition is detected, the control system 201 proceeds back to step 500 where the process is continuously repeated until an unsafe condition is detected. If an unsafe condition is detected, the control system 201 immediately notifies the driver of the unsafe condition at step 502. In some cases, detecting an unsafe condition may comprise receiving data indicating the existence of the unsafe condition from a data source in communication with control unit 200. Notifying the driver at step 502 may comprise notifying the driver through the use of an output device 214 in communication with control unit 200 of the existence of the unsafe condition. For example, the control system 201 could describe the unsafe condition to the driver using the touch screen 316, the vehicle audio system, or any other output device 214.

The control system 201 automatically queries the driver at step 504 in response to the existence of the unsafe condition to determine if the driver would like routing instructions to a safe area. The driver responds to the query through the use of an input device 216 in communication with the control system 201. The control system 201 then receives the input from the driver who is using the input device 216 requesting the routing instructions to the safe area. If routing instructions are not requested, the control system 201 may return to step 500. Otherwise, the control system 201 calculates a route to a safe area in step 506. Step 506 may comprise selecting a safe area and then generating routing instructions to the safe area in response to the input received indicating the request for routing instructions. The control system 201 provides routing instructions to the driver at step 508 to guide the driver to the safe area.

A wide range of problems and conditions can occur while a vehicle is being driven that can make driving unsafe. These problems and conditions may relate to the driver himself (for example, drowsiness, intoxication), to the vehicle (for example, a mechanical problem) or the driving environment (for example, bad weather, heavy traffic). A control system can be configured and programmed to assist the driver in a wide range of circumstances which will make driving safer and easier.

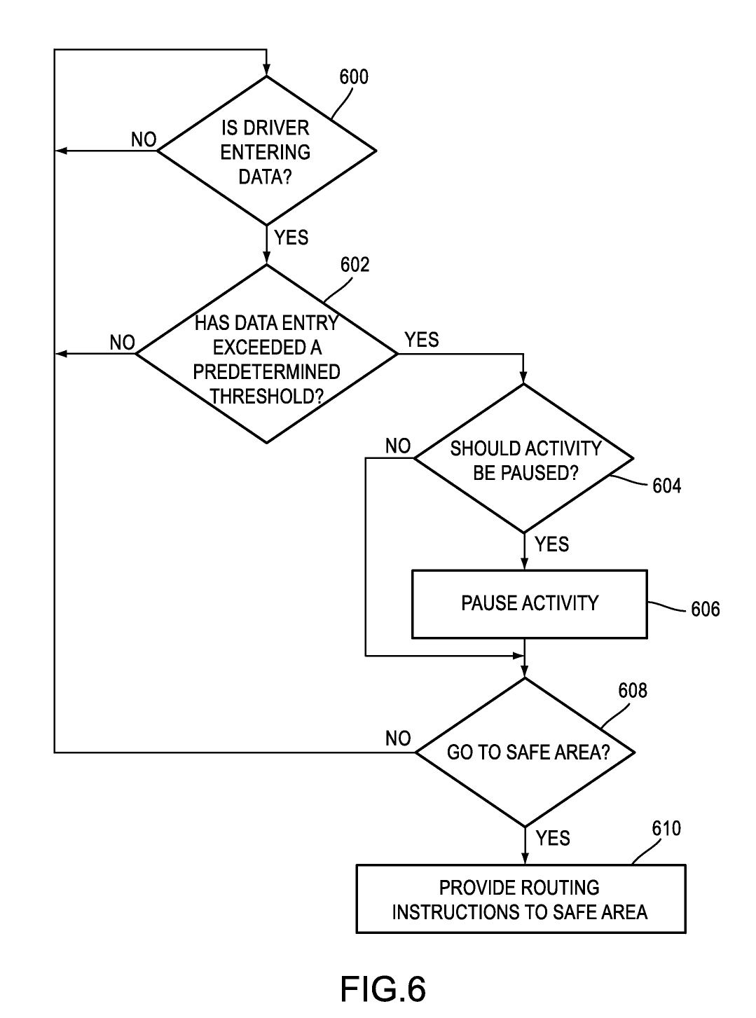

An example of a process that can be carried out by a control system that would increase driving safety is illustrated in FIG. 6. Modern drivers are finding it increasingly more difficult to drive safely, in part because of all the sources of distraction caused by modern technological devices. These devices include portable electronic devices such as cell phones which may be brought into the vehicle and integrated, in-vehicle electronic devices such as the audio/video infotainment center or the electronic navigation system.

Cell phone use is often the cause of unsafe driving practices. Much of the dangers of cell phone use are caused by the glance fixation that occurs while using the cell phone, often during text entry into the cell phone by the driver while driving. Similar dangers can occur when the driver uses an electronic device integrated into the motor vehicle 100. Navigation systems, for example, may require a significant amount of data to be entered into them (such as, for example, an address) or may require data to be entered for a prolonged period of time (or both) before the navigation system can generate information about or generate routing instructions to a desired destination. Extended data entry into a navigation system (or any other on-board device) may require a significant amount of glance or eye fixation on the input device used to enter the data into the navigation system (the touch screen in this example).

It can be understood that in many instances, when an unsafe condition occurs while driving, it is frequently advisable for a driver to find a safe area in the vicinity of the vehicle, to drive to the safe area, to stop the vehicle in the safe area and to deal with the unsafe condition before resuming driving. In the present illustration, the prolonged eye fixation associated with data entry may be deemed an unsafe condition. The control system 201 may be configured and programmed to detect this unsafe data entry condition and to respond to this detected activity. The control system 201 may, for example, be programmed to monitor data entry into all electronic devices integrated into the vehicle 100 (through an input device 216 such as touch screen 316) and to monitor all data entry into all on-board portable electronic devices to detect instances of unsafe data entry.

An embodiment of a method to detect an unsafe data entry condition is illustrated in FIG. 6. At step 600, the control system 201 monitors the all electronic devices in communication with the control unit 200 to detect data entry. If no data entry is detected, the control system 201 returns to step 600 until a data entry event is detected. If data entry is detected, the control system 201 proceeds to step 602 to determine if the data entry has exceeded a predetermined threshold. The control system 201 may be programmed to determine that an unsafe condition exists when data entry continues in excess of a predetermined amount of time, or be programmed to determine that an unsafe condition exists when the amount of data entered exceeds a predetermined or threshold amount (for example, a predetermined number of characters).

If the data entry has not exceeded a predetermined threshold, the control system 201 proceeds from step 602 back to 600 to continue to monitor for further data entry. If further data entry is detected, the control system 201 again proceeds to step 602 to determine if the predetermined threshold has been reached. If the threshold has been reached, the control system 201 determines if the activity (i.e., the data entry task) should be paused. The control system 201 may be programmed to always pause certain tasks (for example, all non-emergency cell phone calls) or to never pause certain tasks (for example, a 911 or other emergency call) or to leave it to the driver's discretion whether to pause the activity or not. In the embodiment of the method shown in FIG. 6, the control system 201 is programmed to query the driver at step 604 to determine if the driver wants to pause the task.

If the driver wishes to pause the activity, the control system 201 pauses it a step 606. If the driver does not wish to pause the activity, the control system may skip step 606. The control system 201 may be programmed to then automatically generate routing instructions to a safe area or can be programmed to query the driver to determine if the driver wants to go to a safe area. In the example shown in FIG. 6, the control system 201 queries the driver at step 608 to determine if the driver wants to go to a safe area. If the driver does, the system provides routing instructions to a safe area at step 610. Otherwise, the system proceeds back to step 600.

It can be understood that the control system 201 can be programmed to handle driver cell phone use or other device use in a wide range of ways. In some situations, the control system 201 is programmed to avoid automatically locking out certain features or devices while the driver is driving. This allows the driver more functionality while driving the vehicle and leaves it to the driver's discretion whether a device or feature of a device (example, using a cell phone) is available to the driver while driving. Locking devices or features of devices out can annoy the driver and reduce the functionality of the equipment in the vehicle (including portable electronic devices in the vehicle). The decision to allow access to certain devices or functions while driving may depend on many factors, however, including the laws of a particular jurisdiction.

As the vehicle travels, it may enter a jurisdiction in which certain activities (for example, cell phone use while driving) are illegal. The system may optionally be programmed to lock out these activities while the vehicle is in that jurisdiction. The control system 201 may also be programmed to notify the driver the activity is illegal, to automatically pause the activity until the vehicle is stopped, to terminate the activity, or to take any other appropriate steps and then to offer routing instructions to a safe area in the various situations.

It can also be understood that while programming the control system 201 to allow certain activities while driving, some of these activities may still be potentially hazardous. Drivers sometimes do not appreciate the risk involved in certain activities such as talking on a cell phone or entering data into an electronic device while driving. Furthermore, there may be no one else in the vehicle to tell the driver that he or she is engaged in a hazardous activity. Even if passengers are present, some passengers may not be aware that the driver's behavior is hazardous. Passengers may be reluctant to tell the driver that his or her behavior is hazardous and that the vehicle should be pulled over until the activity is finished because they don't want to confront the driver or make the driver angry or agitated.

Sometimes the power of suggestion can successfully persuade a driver not to engage in hazardous activity while driving (such as using a cell phone). The capabilities of the control system 201 can be leveraged to promote safer driving in these situations by providing an automatic mechanism to suggest to the driver to pull into a safe area when the control system 201 detects a hazardous activity or other unsafe condition. The control system 201 may generate, for example, a graphic user interface (GUI) on the touch screen 316 (see FIG. 3), a recorded or synthesized voice over an audio output device 214 (see FIG. 2) or through the use of any other output device 214 of the control system 201 to communicate an appropriate suggestion to the driver.

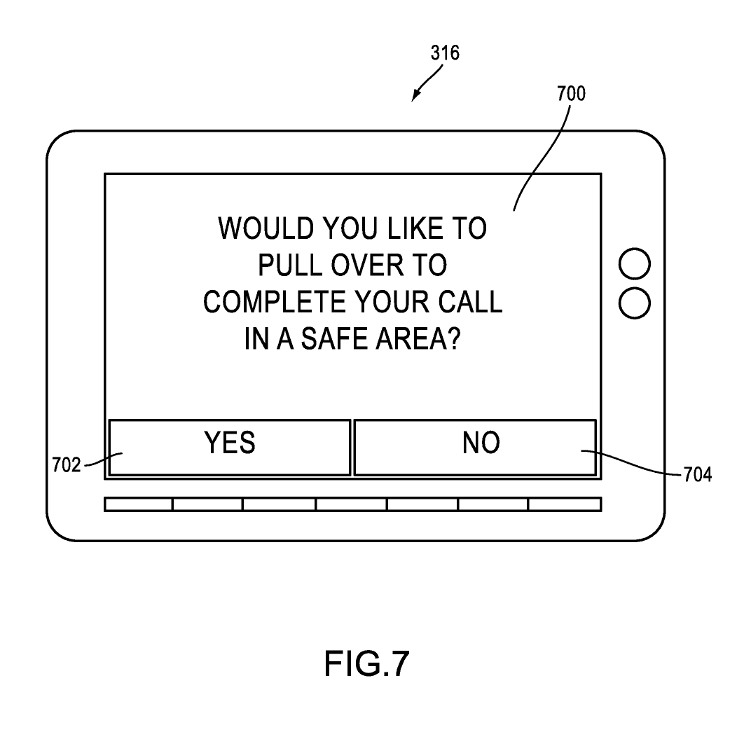

An example of a GUI the control system 201 may be programmed to generate automatically on the touch screen 316 when a cell phone call is detected is shown in FIG. 7. At the top of the touch screen 316, the control system 201 queries the driver at 700 with the prompt “Would you like to pull over and complete your call in a safe area?” This prompt 700 may act as an alert and a suggestion to the driver that his or her cell phone use is hazardous and that it is advisable to pull into a safe area, stop the vehicle, and complete the call before resuming driving. The lower part of the touch screen 316 shows a “Yes” graphic 702 and a “No” graphic 704. The driver can simply touch the “Yes” graphic 702 to receive the routing instructions to the safe area or the “No” graphic 704 to continue driving.

In some embodiments, the control system 201 may activate the automatic routing feature immediately by, for instance, a single touch, a single press or gesture (e.g., pressing an appropriately programmed button), or a single word or command (in an instance in which a voice recognition is provided in the navigation system 114). This allows the control system 201 to receive the driver's input response quickly and in a manner that is easy for the driver. Any other quick or instant way of communicating a response to the control system 201 may also be used. In some embodiments of the control system, the value of the control system 201 to the driver in routing the vehicle to a safe area depends in part on how quickly and easily the driver can interact with the control system 201. In the example embodiment of FIG. 7, the driver is able to quickly and easily request routing instructions to a safe area by simply touching the “Yes” icon 702. The control system 201 may be programmed to automatically pause the cell phone call after the request for routing instructions is received by the control system 201, or, alternatively, the control system 201 may be programmed to let the driver decide if the call should be paused or should continue.

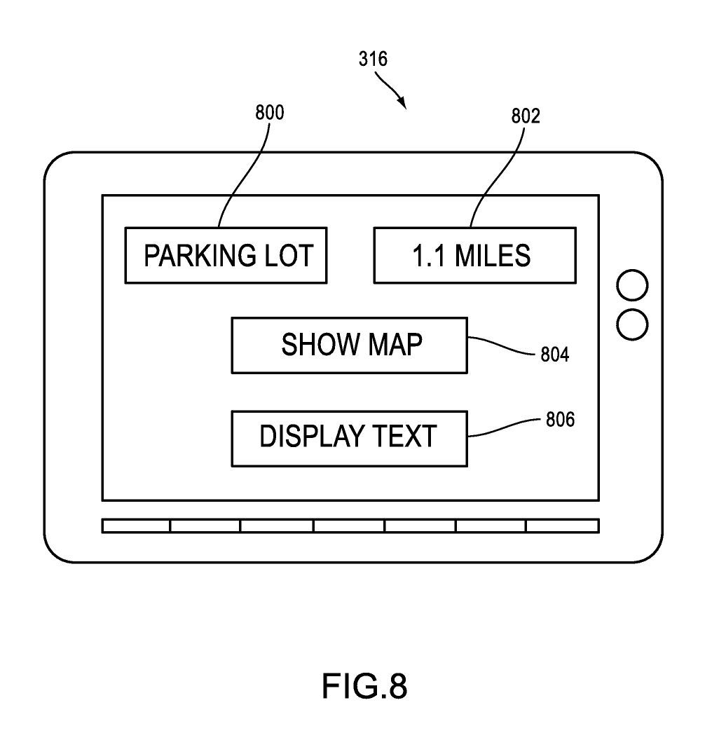

The touch screen display 316 may be used to query the driver in other ways and may be used to display other information. For example, in FIG. 8, the control system 201 may be programmed so that after the driver requests routing instructions to a safe area, the touch screen 316 could display information about the safe area. In this example, the safe area is identified as a parking lot at graphic 800. This informs the driver about what type of facility to be looking for. The example also shows that the screen may display the distance the vehicle is from the safe area as indicated by the graphic 802 which tells the driver the safe area is 1.1 miles away. In this example, the driver is given the option to select a screen format for displaying routing instructions. The driver can select to receive the routing instructions graphically in the form of a map by touching icon 804 labeled “Show Map”. Alternatively, the driver can select to receive the routing instructions in text format by touching icon 806 labeled “Display Text”. It can be understood that the example display of FIG. 8 is optional and is an example only of some of the options that can be programmed into the control system 201. For example, the control system 201 could be programmed to always select a graphic format, a text format, a combined graphic and text format, or any other appropriated format to communicate the routing instructions to the driver. It can also be understood that routing instructions on the touch screen 316 could be accompanied by audible routing instructions, or that the routing instructions could be given entirely audibly or through any other appropriate output type.

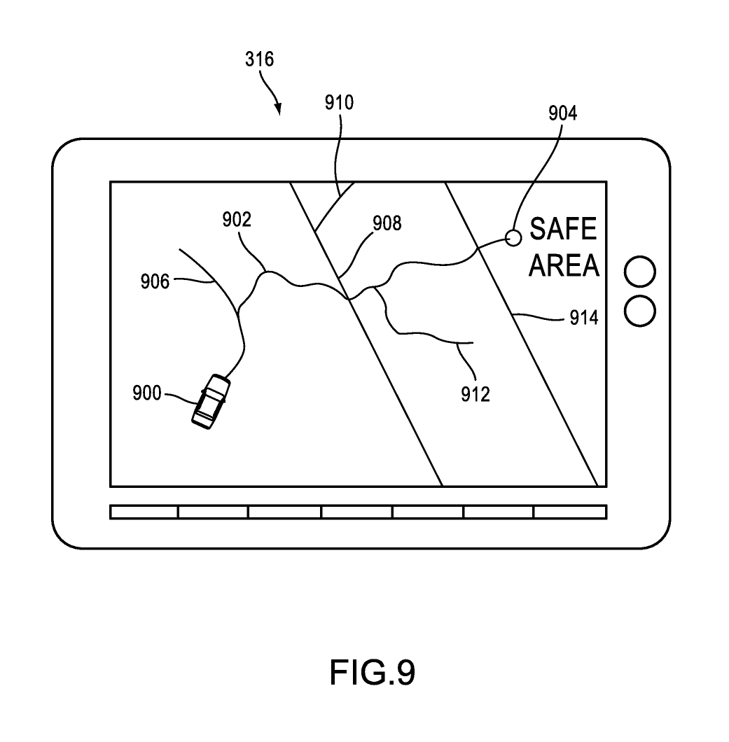

FIG. 9 shows an example display that the control system 201 may generate if the routing instructions are displayed graphically. The touch screen 316 shows a map of the area in the immediate vicinity of the motor vehicle 100. The motor vehicle 100 is represented by an automobile icon 900 which shows the location and heading of icon 900 along road 902. The touch screen 316 indicates the location of the safe area with a circular icon 904 which is accompanied by the words “Safe Area”. The words “Safe Area” are for illustrative purposes only. The control system 201 can be programmed to display any appropriate text or graphics. In some embodiments, for example, more descriptive wording could be used, such as, the name of the destination (e.g., the name of a particular business that may have an appropriate parking lot), the type or category of the safe area (e.g., a type of business could be given such as “Service Station”) and so on. The map on the touch screen 316 also shows side street 906, side street 908, side street 910, side street 912, and side street 914. The side streets may be labeled with street names depending of the scale of the map.

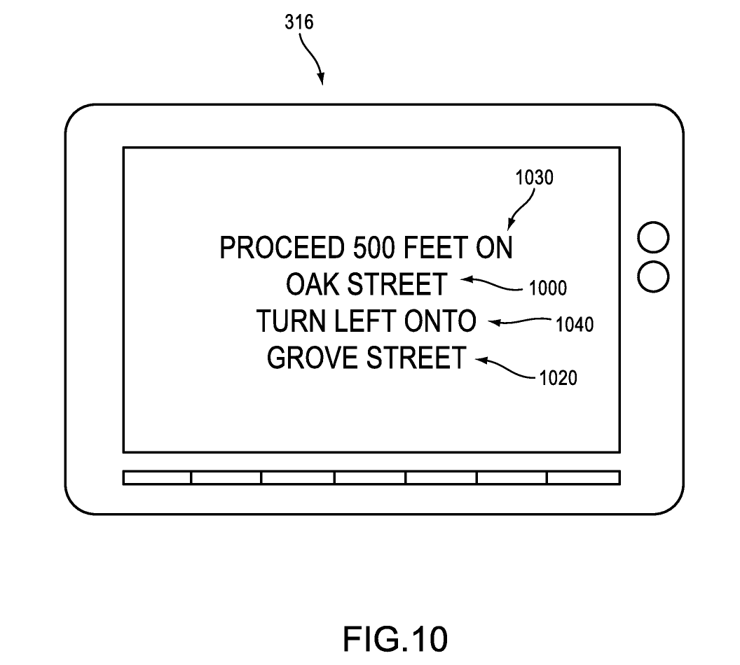

FIG. 10 shows an example display that the control system 201 may generate if the routing instructions are displayed in text format. The display indicates the street the driver is currently on (“Oak Street” in this example) in the second line 1000 of the display. The street the driver is looking to turn onto (“Grove Street”) is indicated on line four 1020 of the display. The distance the driver has to travel (on Oak Street where the vehicle is located) to reach the next street (Grove Street in this example) is given on the first line 1030 of the display (i.e., the driver has to travel another 500 feet on Oak Street to reach Grove Street). The direction of the next turn is given on the third line 1040 (i.e., the driver is to turn “Left” in this example).

The examples of shown in FIGS. 7-10 are intended to be illustrative only. It can be understood that a wide range of information can be displayed or otherwise conveyed to the driver including, but not limited to, the type or category of the safe area, the name of the safe area (for example, the name of a particular retail business, municipal building, hotel, service station, etc.), and/or the estimated time of arrival (ETA) at the safe area.

In different embodiments, various methods can be used for selecting a safe area. In some cases, the control system 201 may be programmed to search for the nearest safe area that meets any prerequisite conditions, such as finding the nearest safe area where a driver may make a phone call or sleep. Furthermore, in some cases, the control system 201 may determine the closest safe area using the location, speed and heading of the motor vehicle 100.

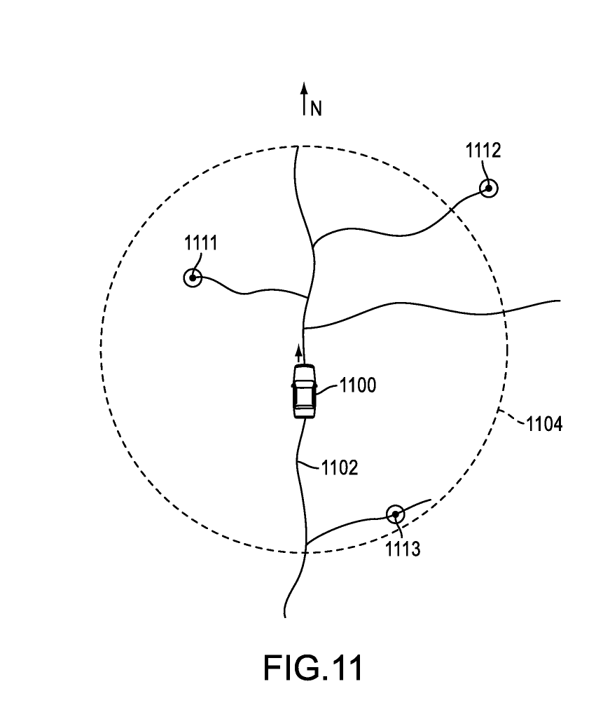

FIG. 11 illustrates a schematic view of a motor vehicle 1100 traveling on roadway 1102. Upon detecting an unsafe condition, a control system associated with motor vehicle 1100 may search for nearby points of interest to locate a safe area where motor vehicle 1100 can be stopped. To select a point of interest as a safe area for the motor vehicle 1100, the control system could consider any operating conditions including, but not limited to the location, speed and heading of the motor vehicle 1100.

In this situation, the control system searches for and locates three points of interest, including first point of interest 1111, second point of interest 1112 and third point of interest 1113. Furthermore, the control system determines the region 1104 where the motor vehicle 1100 can travel in the predetermined time. Since second point of interest 1112 is located outside of the region 1104, it is excluded as a candidate for a safe area. In addition, the control system could consider the current heading of the motor vehicle 1100, which is due north. Since first point of interest 1111 is north of the motor vehicle 1100 and second point of interest 1113 is located south of the motor vehicle 1100, the control system may select first point of interest 1111 as the best candidate for a safe area.

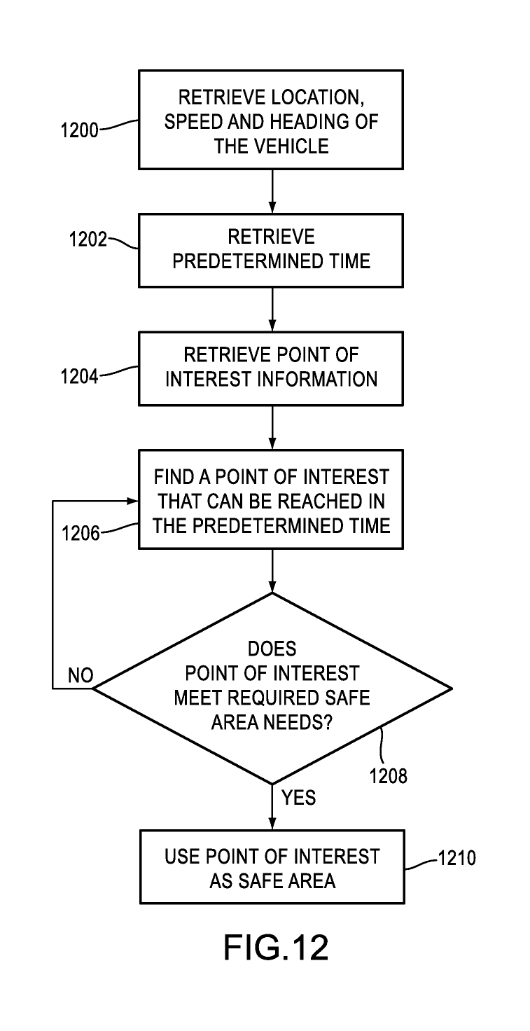

FIG. 12 illustrates an embodiment of a process for selecting a safe area. In some cases, some of the steps may be performed by control system 201. In other cases, however, some of the steps could be performed by any other component or system. Moreover, it will be understood that in some cases, one or more of the following steps could be optional.

In step 1200, the control system 201 may retrieve the location, speed and heading of the vehicle. In some cases, the control system 201 may only retrieve the location. In some cases, the control system 201 may only retrieve the speed. In still other cases, the control system 201 may only retrieve the heading. Moreover, in some cases, the control system 201 may retrieve any combination of the location, speed and heading of the motor vehicle.

The location, speed and/or heading information can be determined from GPS information, as well as from various sensors monitoring the speed and/or heading of the vehicle. In step 1202, the control system 201 may retrieve a predetermined time. The predetermined time could be a fixed time, or it could be a variable time. In some cases, the predetermined time could vary according to the type of unsafe condition detected. In particular, some unsafe conditions may require a vehicle to be stopped more quickly than others. For example, a driver who is texting can afford to wait several minutes before pulling over to a safe area, as long as the texting is halted during travel to the safe area. However, a mechanical malfunction such as a deflated tire may require that the vehicle is brought to a safe area much more quickly. In embodiments where the predetermined time may vary, the control system may use a table to select a predetermined time as a function of the type of unsafe condition detected.

In step 1206, the control system 201 may retrieve point of interest information. In some cases, the control system 201 may search an onboard or remote database for local points of interest. In some cases, the search may be done for all types of points of interest. In other cases, the search may be done only for points of interest within a particular category or within multiple categories. This step provides the control system 201 with a set of possible safe areas, which may be further reduced upon further considering how far it might take the motor vehicle to travel to them.

The term “point of interest” as used throughout this detailed description and in the claims refers to any geographic location that is associated with additional information that indicates the possible presence of a parking lot, building or other facilities where a vehicle may stop. In particular, the term point of interest is not intended to be limited to particular kinds of locations including retail locations, places of business, or public properties.

In step 1208, the control system 201 may find a point of interest that can be reached in the predetermined time. In situations where multiple points of interest can be reached within the predetermined time, the control system 201 may select the point of interest that can be reached in the shortest time. Any methods of determining the travel time to a point of interest known in the art can be used, including any algorithms for finding travel times between two geographic locations.

In some cases, the control system 201 may proceed to step 1208 and step 1210. However, it will be understood that in some cases, step 1208 and step 1210 may be optional steps. In step 1208, the control system 201 may determine if the point of interest meets the required safe area needs. For example, if the unsafe condition is low fuel, the control system 201 must find a safe area that provides fuel services, such as a gas station. In this case, if the closest point of interest is a shopping mall with no gas stations, the control system 201 must continue searching for the next closest point of interest that provides fuel services.

If the control system 201 determines that the currently selected point of interest does not meet the required needs relevant to the unsafe condition, the control system 201 may return to step 1206 to determine a new point of interest that can be reached within the predetermined time. Otherwise, if the control system 201 determines that the currently selected point of interest does meet the required needs, the control system 201 may proceed to step 1210 to use the point of interest as the safe area. At this point, the control system 201 may provide routing instructions to the safe area and/or notify the user as discussed in the previous embodiments.

If the control system 201 is not able to find a safe area that can be reached within the predetermined time, the control system 201 may be programmed to determine if the vehicle is in a location (e.g., a city street where vehicles can be parked or can pull over, a country road, a highway with a wide shoulder or median where vehicles can pull over) where the vehicle is able to be pulled over to the roadside and then to suggest to the driver that he or she pull the vehicle over to the roadside to deal with the hazard or event. If it is not possible to find a location where the vehicle can pull over to the side of the road, and if a safe area cannot be reached with the predetermined time, the control system 201 can be programmed to find the nearest safe area, to calculate an estimated time of arrival for this location and then to suggest to the driver the possibility of driving to this closest area and providing the driver with the ETA to help the driver make a decision. Providing this ETA to the driver is important because it gives the driver an expectation of how long it will take to reach a safe location, especially if the task at hand is an urgent matter (e.g., an extremely important phone call).

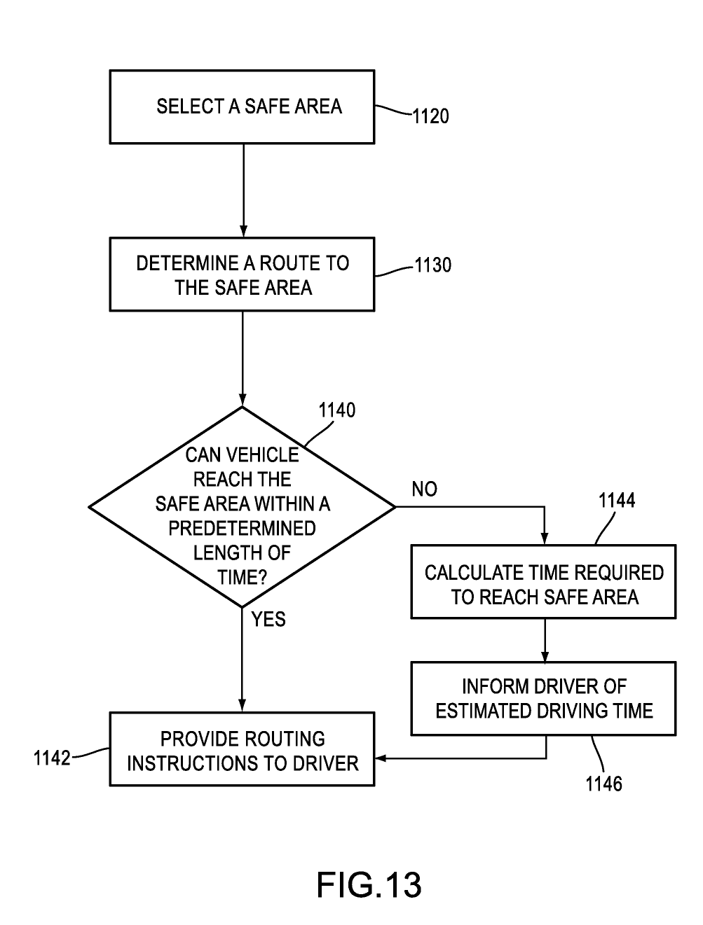

An embodiment of a process for determining if a vehicle can reach a safe area within a predetermined time is illustrated in FIG. 13. According to the method, the control system 201 selects a safe area at step 1120. The control system 201 may be programmed to select the safe area according to several different criteria at step 1120. For example, the control system can select one or more safe areas of any type (i.e., that can be in any category such as retail store, hotel, service station, etc.). The control system 201 may be programmed to calculate or determine a route to one or more of the selected safe areas at step 1130. Determining a route in step 1130 may include determining or calculating the time required for the motor vehicle 100 to reach each of the safe areas selected in step 1120. The control system 201 may be programmed to compare the estimated travel time to each of the selected safe areas to a predetermined time (e.g., 5 minutes) at step 1140 to determine if the ETA is less than the predetermined time. If a safe area that can be reached within the predetermined time is located, the control system 201 may be programmed to, for example, select the first such safe area and route the vehicle to that safe area or may be programmed to compare the ETA of all safe areas selected in step 1120 and select the closest. Once the system has selected a safe area that can be reached within the predetermined time, the control system 201 can provide routing instructions to the driver at step 1142. This step could be preceded by querying the driver to determine if the driver wants to be routed to a safe area, or preceded by or followed by any of the steps described herein in connection with any of the other methods or processes of the present embodiments.

If the control system 201 is unable to locate a safe area that can be reached within the predetermined time at step 1140, the control system 201 may calculate the ETA at the safe area at step 1144 if this was not done in an earlier step. The control system 201 then informs the driver of the estimated amount of time required to reach the safe area in step 1146. The control system 201 may then provide the routing instructions to the driver at step 1142. This step could be preceded by querying the driver to determine if the driver wants to be routed to a safe area, or preceded by or followed by any of the steps described herein in connection with any of the other methods of processes of the present embodiments.

In some embodiments, the control system 201 may be programmed to take into account the vehicle's location, heading, speed and route calculation time when searching for safe areas that can be reached within the specified time (5 minutes in our example) or when searching for any other safe area. For example, if the vehicle is being driven at high speed on a multilane highway, a safe area could be quickly passed and no longer accessible if the driver is unable to make the necessary lane changes or reach a necessary exit off the highway.

In some embodiments, the control system 201 may be programmed to provide the driver with a predetermined or minimum amount of time to make traffic maneuvers such as, for example, lane changes. This will assure that the driver has sufficient time to make the traffic maneuvers necessary to follow the turn-by-turn routing instructions given by the control system 201 when guiding the vehicle to a safe area. The control system 201 may also be programmed to consider other factors such as time of day (e.g., the amount of daylight available), amount of traffic, weather conditions and so on when determining the amount of time a driver should be given for each traffic maneuver. The control system 201 may be programmed to provide a fixed amount of time for each traffic maneuver or a variable amount of time each traffic maneuver (which may be based on an estimate of the time needed to give the vehicle's location, heading, speed and other factors).

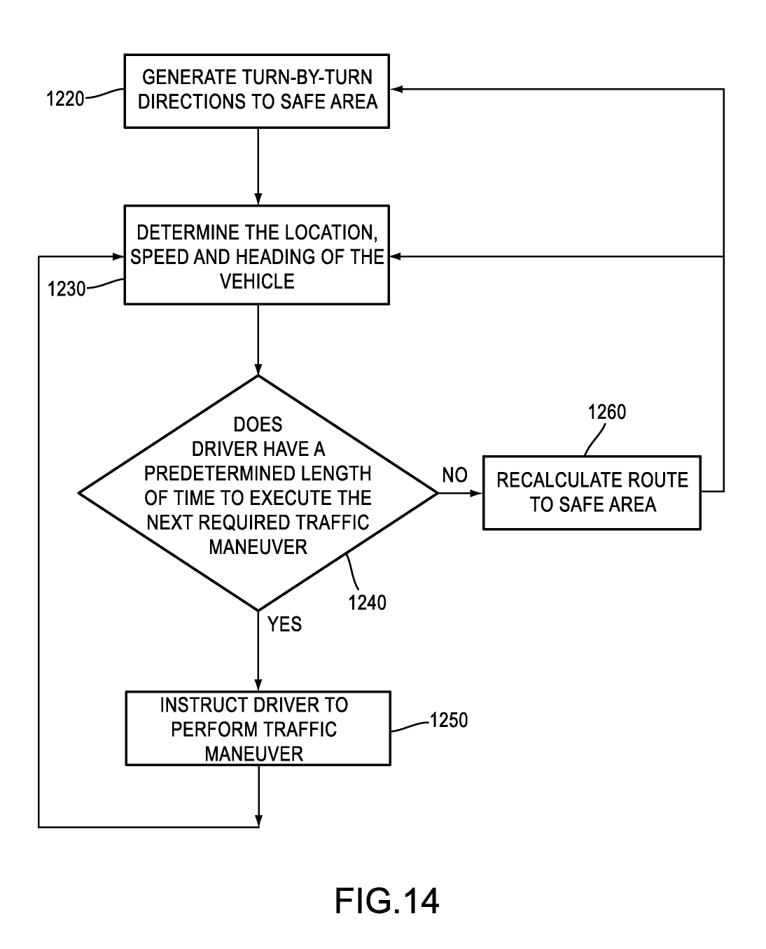

An example of a process for determining if a driver has a sufficient amount of time to execute a traffic maneuver (that is, a traffic maneuver the driver is required to make in following a particular routing instruction in a series of routing instructions that will guide the vehicle to the safe area) is shown in FIG. 14. The control system 201 generates turn-by-turn routing instructions or directions to a selected safe area at step 1220. At step 1230, the control system 201 determines the location, speed and heading of the vehicle. Using information stored in the data storage unit 204 including the location, speed and heading data, the system determines at step 1240 if the vehicle has a predetermined length of time to execute the next required traffic maneuver. For example, the driver may be required to make one or more lane changes and exit a highway in order to follow a particular routing instruction. If the control system 201 determines that the driver does have sufficient time to execute the traffic maneuver, the system uses an output device 214 such as touch screen 316 to instruct the driver to perform the traffic maneuver at step 1250. The process then returns to step 1230 to perform the process for the next routing instruction in the series. If the system determines at step 1240 that the driver does not have the predetermined amount of time to make the traffic maneuver or maneuvers required to follow the next routing instruction, the system may be programmed to recalculate a new set of routing instructions to the selected safe area at step 1260. The process then returns to step 1230 to begin execution of the new set of routing instructions.

It can be understood that this example is intended to illustrate possible ways the control system 201 can operate and is not intended to limit the functions that can be performed by the control system 201. Depending upon the circumstances, if a particular routing instruction cannot be executed or if a driver misses a turn or otherwise is unable to execute a particular routing instruction for any reason, the system may be programmed calculate a new route to the selected safe area. In some cases, if the selected safe area is now going to take longer than a predetermined amount of time to reach, the system could select a new safe area.

It can be understood that in some instances (e.g., a cell phone call), the services and amenities provided by a safe area are not important. In other instances, the products, services and amenities may be important in the selection of a safe area. For example, if a driver has a mechanical problem with the vehicle, it may be desirable to find a safe area that offers vehicle repair services that can be reached within a specified or predetermined amount of time. If a driver is drowsy, it may be desirable to find a safe area where the driver can sleep overnight (e.g., a hotel or motel) that can be reached within a specified or predetermined amount of time.

As discussed above, the POI's in a navigation database associated with the control system 201 or service provider 220 that may be categorized by type. The control system 201 may be programmed to respond to particular unsafe conditions on a case specific basis. That is, the system may be programmed to give preference to finding a safe area in a particular category or categories for a given unsafe condition that is detected by the system.

For example, if the control system 201 determines that the vehicle is running low on fuel, the system may be programmed to give priority to selecting a safe area from a “Service Stations” (or similar) category. If the nearest service station cannot be reached given the amount of fuel in the vehicle, the control system 201 may be programmed to find a safe area in another category (or categories) or to find the nearest safe area in any category. As another example, if the system detects that a tire is losing air pressure, the system may be programmed to give priority to finding a safe area that provides tire service (e.g., vehicle repair facility, a gas station, a retail tire store, etc.). If a safe area in a particular category is not close enough, the control system 201 may be programmed to find a safe area in another category (or categories) or to find the nearest safe area in any category.

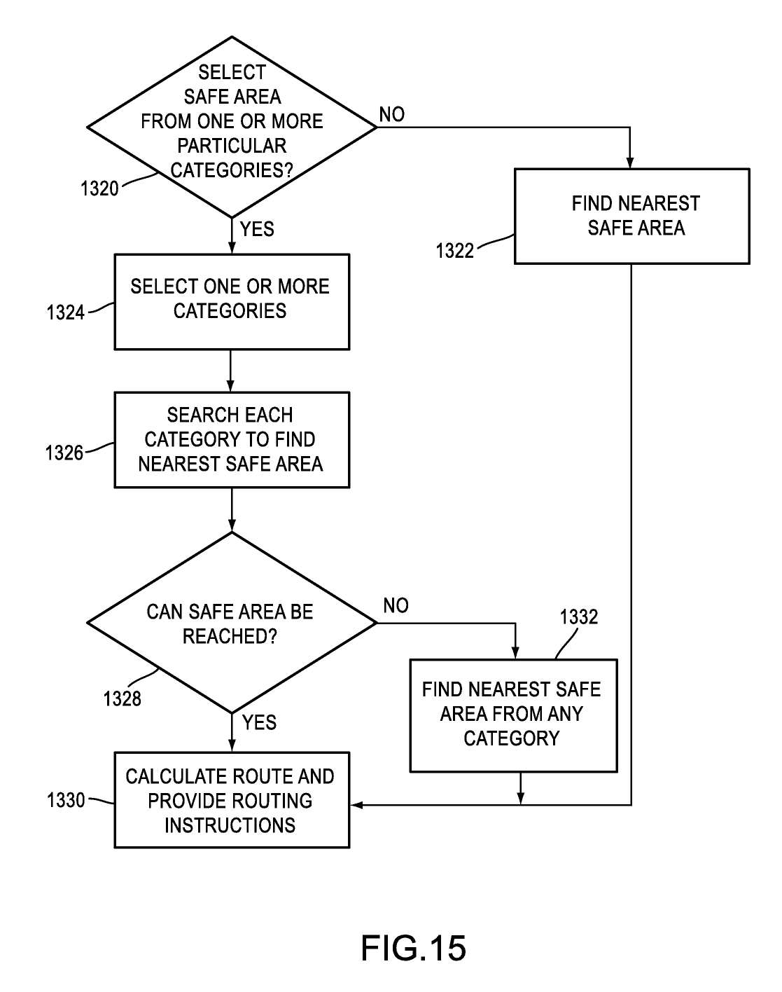

FIG. 15 illustrates a process for selecting a safe area if the unsafe condition that is detected by the control system 201 is preferably handled by a safe area in a particular category. At step 1320, the system determines if the detected unsafe condition can best be handled by routing the vehicle to a safe area in a particular category. If the services provided by the safe area do not matter, the control system 201 finds the nearest safe area at step 1322. Following step 1322, the control system 201 may proceed to step 1330, which is discussed below.

If, during step 1320, the control system 201 determines that the vehicle should be routed to a facility in a particular category to deal with the detected unsafe condition, the process selects one or more appropriate categories at step 1324. At step 1326, the control system 201 searches each selected category to find the nearest safe area in each category. At step 1328 the control system 201 determines if the nearest safe area from the categories selected at 1324 can be reached. For example, if the vehicle is low on fuel and the control system 201 locates the nearest safe area that provides fuel, the system determines at step 1328 if that safe area can be reached. In some cases, during step 1328, the control system 201 determines if the safe area can be reached in a predetermined time. If it can be reached, the control system 201 provides routing instructions to the driver at step 1330. If the nearest safe area from the selected categories cannot be reached, the control system 201 may be programmed to find the nearest safe area from any category at step 1332.

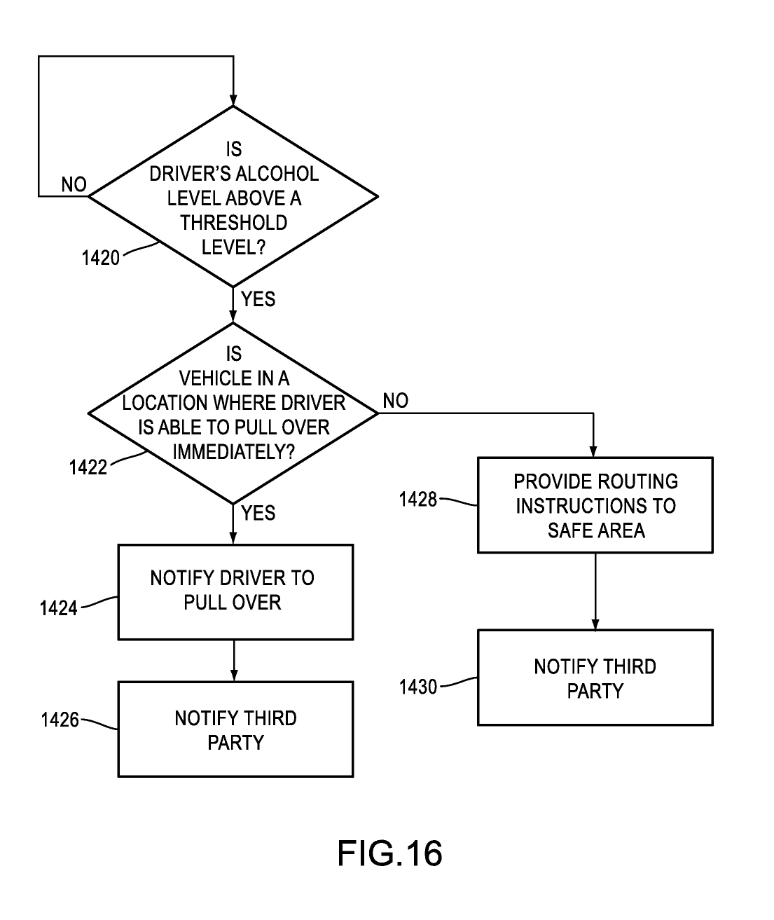

In some embodiments, the control system 201 may be programmed to handle specified unsafe conditions in a particular way. For example, the control system 201 may include sensors to determine if the driver is intoxicated. In this instance, the control system 201 may carry out the process illustrated in FIG. 16. At step 1420, the system receives data from an on-board alcohol sensor monitoring the driver and determines if the driver's alcohol level is above a threshold level. If the driver's alcohol level is not above the threshold level, the process follows the “no” loop and continues to monitor the driver's alcohol level.

If the control system 201 determines that the driver's alcohol level is above a threshold level, the control system 201 determines at step 1422 if the vehicle is in a location where the vehicle can be pulled over immediately. If the vehicle is in a location where the vehicle can be pulled over immediately, the system may be programmed to notify the driver to pull over immediately at step 1424. If the driver pulls over as suggested at step 1424, the control system 201 may be programmed to notify a specified third party. In some cases, the control system 201 may notify the third party of the vehicle's location and/or of the condition of the driver at step 1426.

If the control system 201 determines at step 1422 that the vehicle is not in a location where the vehicle can be pulled over immediately, the control system 201 may be programmed to provide routing instructions to the nearest safe area at step 1428. In some cases, the system may also be programmed to notify a pre-selected third party at step 1430. In some cases, the third party can be notified of the vehicle's speed, heading and/or location. In some cases, the third party can be notified of the driver's condition. This allows a third party to meet up with the driver and provide further transportation for the intoxicated driver.

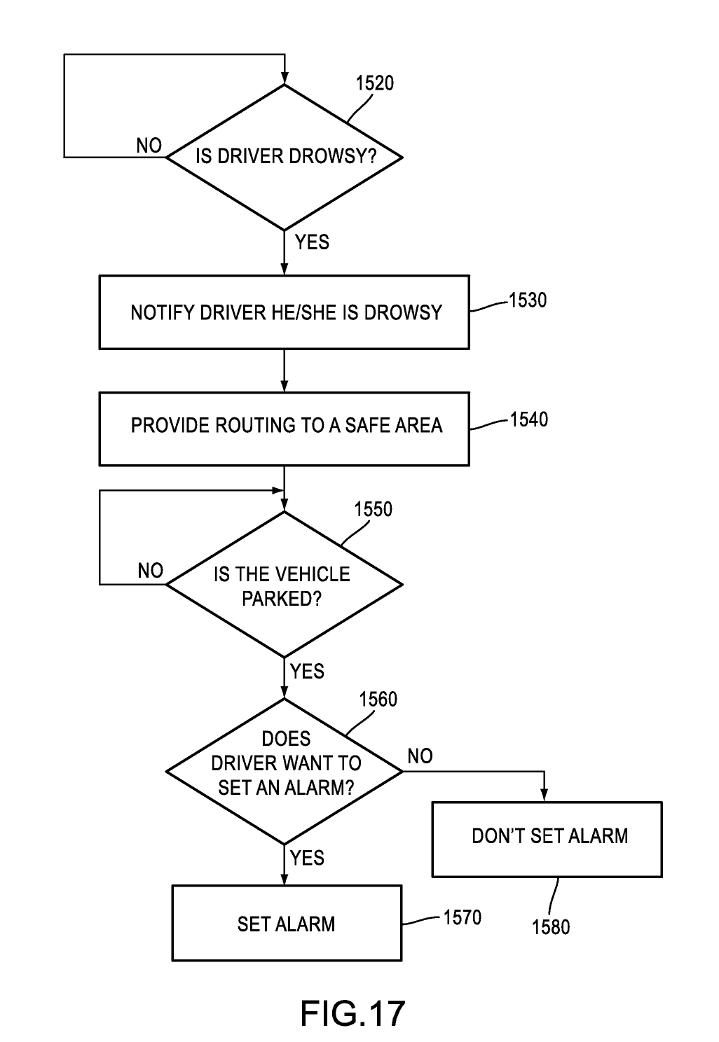

As another example, the control system 201 may include sensors to determine if the driver is drowsy. An embodiment of such a process is illustrated in FIG. 17. At step 1520, the control system 201 receives data from an on-board drowsiness sensor monitoring the driver and determines if the driver is drowsy. If the driver is not drowsy, the control system 201 follows the “no” loop off of step 1520 and continues to monitor the driver to determine if the driver is drowsy. If the system determines that the driver is drowsy, the control system 201 may be programmed to notify the driver that he/she is drowsy at step 1530. In some cases, this notification may consist of generating a sound through the use of an output device that is loud enough to keep the driver awake. In other cases, additional systems of the vehicle could be activated to alert a driver. For example, in some cases, a visual indicator could be activated.

The control system 201 may then be programmed to provide the driver with routing instructions to a safe area at step 1540. This safe area may be selected from a particular category (for example, from a category that provides overnight accommodations) or may be selected from the nearest safe area regardless of category. Next, at step 1550, the control system 201 may determine if the vehicle has been parked, following routing to the safe area. The control system 201 may wait until the vehicle has been parked before proceeding to step 1560.

In step 1560, the control system 201 may provide the option of setting an alarm for the driver. This allows a driver the opportunity to sleep or nap, before resuming driving. In some cases, the control system 201 could provide this alarm option using any type of output device, including a touch screen device. If the driver wants to set an alarm, the control system proceeds to step 1570, where a user may set an alarm using any type of input device. Otherwise, the control system 201 proceeds to step 1580 where no alarm is set. With this arrangement, the control system 201 provides a means for a driver to rest for a predetermined time (which is determined by the alarm setting) before resuming driving.

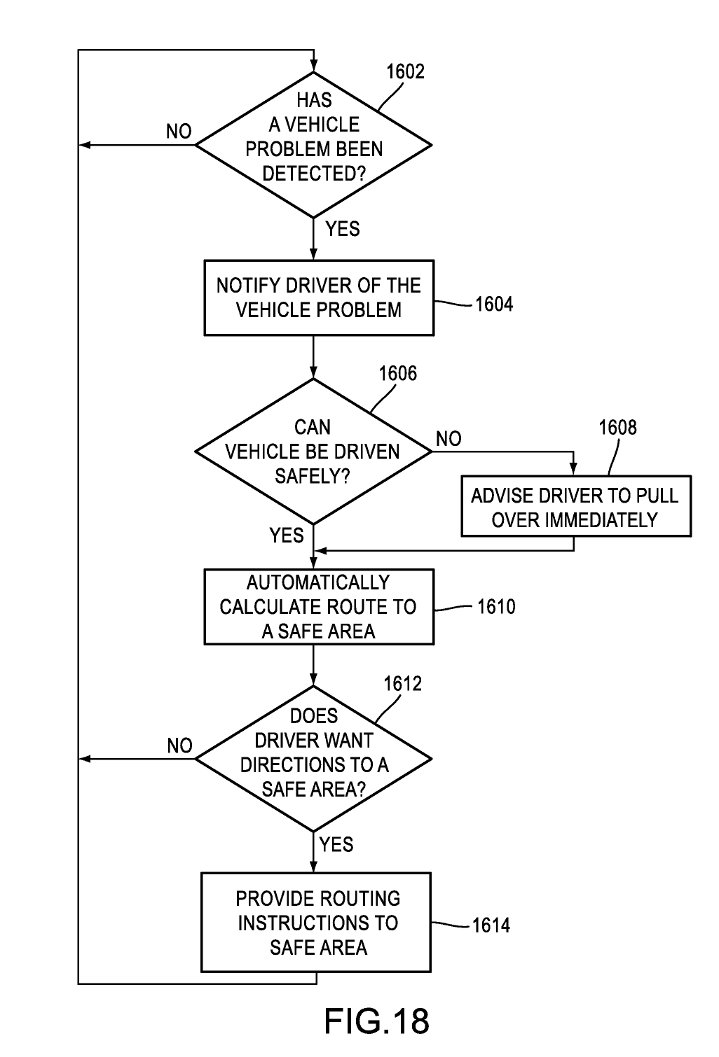

As another example, the control system 201 may include sensors to determine if a vehicle should be routed to a safe area due to a vehicle problem, such as a mechanical problem. An embodiment of a process for automatically routing a vehicle to a safe area when mechanical problems occur is illustrated in FIG. 18. Starting at step 1602, the control system 201 may determine if a vehicle problem has been detected. Examples of different vehicle problems include mechanical problems, such as engine problems, transmission problems, braking problems as well as any other kinds of mechanical problems that may occur in a vehicle. Moreover, some vehicle problems may be the failure of one or more electrical systems, or malfunctioning of various systems such as one or more diagnostic systems.

If a vehicle problem is detected, the control system 201 proceeds to step 1604. In step 1604, the control system 201 may notify the driver of the vehicle problem. This could be achieved using any visual, audible and/or tactile indicators. In one embodiment, the driver may be notified using a message displayed on a display device. In another embodiment, the driver may be notified by an audible warning or message.

In step 1606, which follows step 1604, the control system 201 determines if the vehicle can be driven safely. For example, in situations where the vehicle problem is a punctured tire, the vehicle should be immediately pulled over rather than driven any substantial distance. However, in situations where the vehicle problem is a malfunctioning oxygen sensor, the vehicle may be driven for some distance before intervention is needed. If the control system 201 determines that the vehicle cannot be driven safely at step 1606, the control system 201 may advise the driver to pull over immediately at step 1608. If, on the other hand, the control system 201 determines that the vehicle can be driven safely, the control system 201 may automatically calculate a route to a safe area. As previously discussed, the safe area could be chosen according to distance and/or type. For example, if the vehicle problem is a mechanical problem, the safe area could be a repair shop.

In step 1612, the control system 201 may determine if the driver wants directions to the safe area. If not, the control system 201 proceeds back to step 1602 to monitor for further vehicle problems. Otherwise, the control system 201 may proceed to step 1614 where directions to the safe area may be provided to the driver.

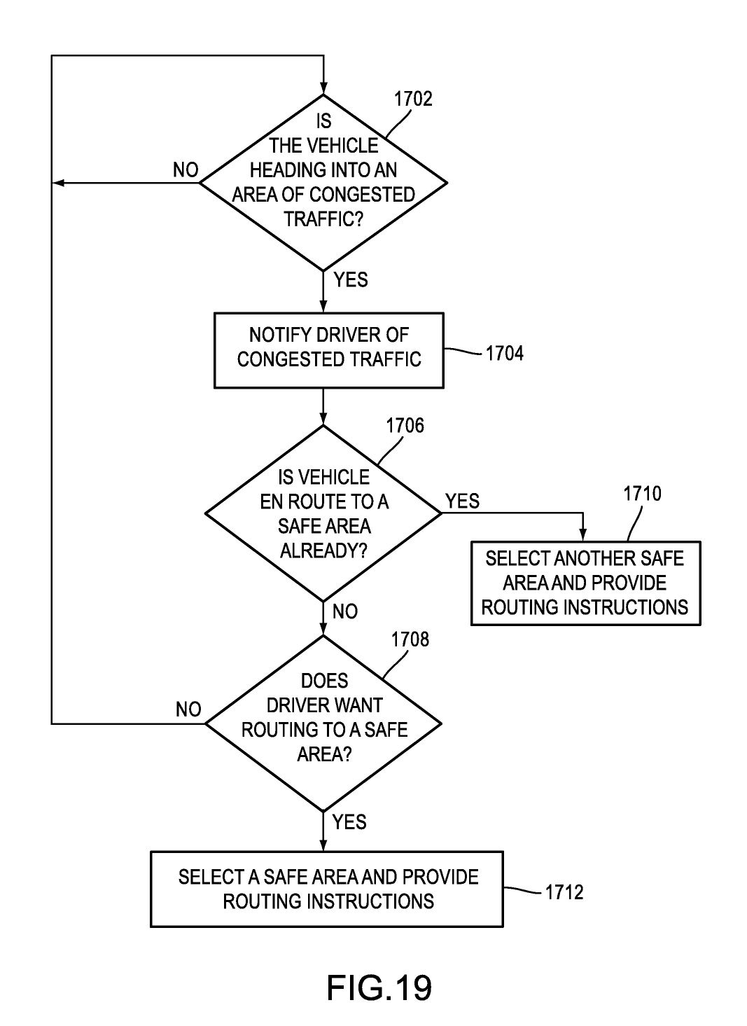

FIG. 19 illustrates an embodiment of a process that may be used in situations where a vehicle may be routed to a safe area to due to traffic congestion. Starting at step 1702, the control system 201 may determine if a vehicle is heading into an area of traffic congestion. In some cases, the control system 201 may determine the traffic conditions along a current route or in nearby areas by consulting a service provider, which may have access to historical or real time traffic data. In other cases, the control system 201 could use traffic information received from nearby vehicles through a vehicle communication network. In still other cases, the control system 201 could use traffic information stored in an onboard database or memory device.

In step 1704, the control system 201 may notify the driver of the congested traffic along the current route or in a nearby area. The driver could be notified using any output device. Moreover, the driver could be notified using visual, audible or tactile means. In step 1706, the control system 201 may determine if the vehicle is already en route to a safe area. For example, if a driver is stuck in traffic on a highway, the driver may already be pulling off at a nearby rest stop. If so, the control system 201 may select another safe area and provide routing instructions to that safe area.

If the control system 201 determines that the vehicle is not already driving towards a safe area in step 1706, the control system 201 may query the driver to determine if the driver wants to be routed to a safe area at step 1708. If not, the control system 201 returns to step 1702. Otherwise, the control system 201 may select a safe area and provide routing instructions for the driver in step 1712.

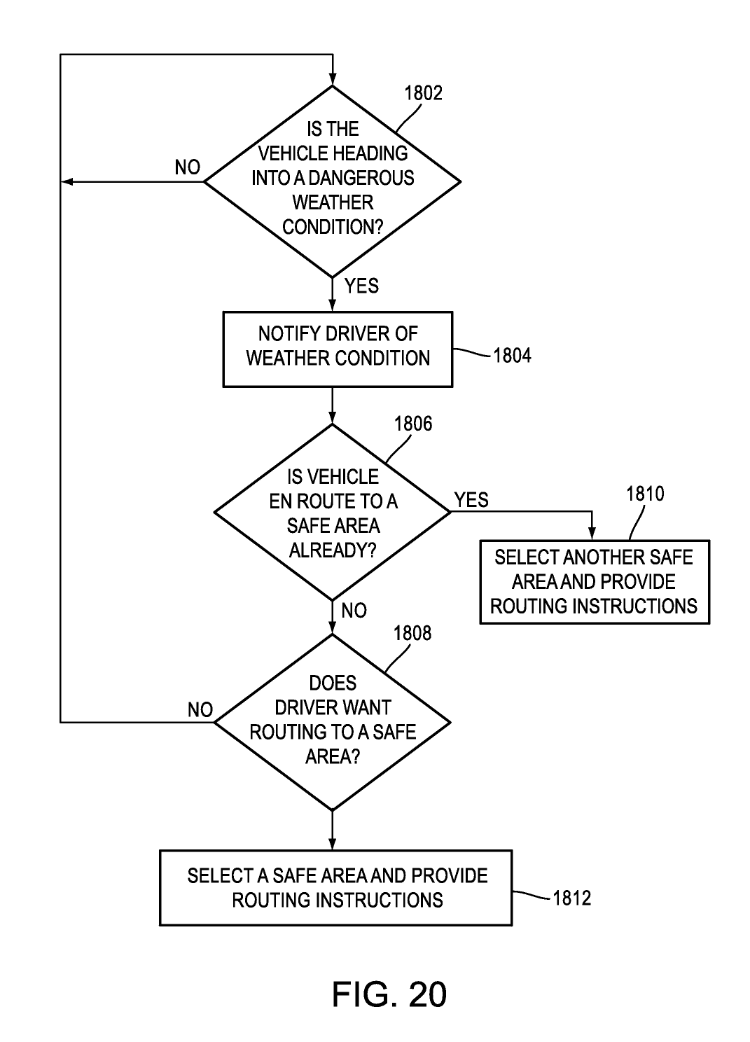

FIG. 20 illustrates an embodiment of a process that may be used in situations where a vehicle may be routed to a safe area to due to dangerous weather conditions. The term “dangerous weather conditions” is not intended to be limiting and can vary in different contexts. Examples of dangerous weather conditions can include, but are not limited to: thunderstorms, heavy rain, tornados, hurricanes, flooding, high winds, icy road conditions, wet road conditions, snow, sleet, hail as well as any other types of weather conditions that could present increased driving difficulties.

At step 1802, the control system 201 determines if the vehicle is heading into a dangerous weather condition. If so, the control system 201 proceeds to step 1804. At step 1604, the control system 201 may notify the driver of the weather condition. For example, if the weather condition is snow, the control system 201 may announce the weather condition using an audible message, or by displaying the weather condition on a display device.

Information related to weather could be provided from any source. In some cases, the weather conditions could be determined through information received from a service provider. As discussed above, some service providers may include one or more weather databases that store historical and/or real time weather information. In other cases, the weather conditions could be determined from information received from nearby vehicles through a vehicle communication network. In still other cases, the weather conditions could be received from a weather alert service, which may transmit weather information over various different wireless networks or over AM, FM or satellite radio.

In step 1806, the control system 201 may determine if the vehicle is already en route to a safe area. If so, the control system 201 may select another safe area and provide routing instructions to the new safe area at step 1810. If, during step 1806, the control system 201 determines that the vehicle is not already en route to a safe area, the control system 201 may proceed to step 1808. In step 1808, the control system 201 may determine if the driver wants to be routed to a safe area. If the driver does not wanted to be routed to a safe area, the control system 201 proceeds back to step 1802. If the driver does want to be routed to a safe area, the control system 201 may select a safe area and provide routing instructions to the safe area at step 1812.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A method of using a control unit to provide a vehicle driver with routing instructions to a safe area when an unsafe condition is detected, the method comprising:
receiving data indicating the existence of the unsafe condition from a data source in communication with the control unit;
selecting the safe area;
automatically generating routing instructions to the safe area in response to said receiving data indicating the existence of the unsafe condition;
notifying the vehicle driver through the use of an output device in communication with the control unit of the existence of the unsafe condition and of the availability of routing instructions to the safe area; and
communicating the routing instructions to the driver in response to the actuation of an input device in communication with the control unit.

2. A method of using a control unit as recited in claim 1, wherein said selecting further comprises selecting a safe area that can be reached within a predetermined amount of time.

3. A method of using a control unit as recited in claim 1, wherein said selecting further comprises selecting the nearest safe area.

4. A method of using a control unit as recited in claim 3, wherein said selecting further comprises selecting a safe area that will require more than a predetermined amount of time to reach, the method further comprising communicating to the driver the estimated amount of time required to reach the safe area.

5. A method of using a control unit as recited in claim 1, said communicating routing instructions further comprising giving turn-by-turn directions wherein said giving turn-by-turn directions comprises determining the location, speed and heading of the vehicle and determining that the driver has at least a pre-determined amount of time to make a traffic maneuver.

6. A method of using a control unit as recited in claim 5, wherein the output device includes a display unit, said notifying the vehicle driver further comprising notifying the vehicle driver through the use of the display unit.

7. A method of using a control unit as recited in claim 1, wherein the output device includes an audio output unit, said communicating the routing instructions further comprising communicating the routing instructions to the driver audibly.

8. A method of using a control unit as recited in claim 6, wherein said communicating the routing instructions further comprises displaying the routing instructions on the display unit in text format.

9. A method of using a control unit as recited in claim 6, wherein the display unit is a touch screen device, said communicating the routing instructions to the driver occurring in response to the actuation of the touch screen device.

10. A method of using a control unit as recited in claim 1, wherein said selecting further comprises selecting a safe area from a collection of data in which the safe areas are in categories by type, said selecting further comprising selecting one or more categories to search to select a safe area.

11. A method of using a control unit as recited in claim 10, said selecting further comprising selecting the nearest safe area from a subset of categories.

12. A method of using a control unit as recited in claim 1, wherein the data source is a sensor monitoring the driver, said receiving data further comprising receiving data indicating the existence of a dangerous condition associated with the driver.

13. A method of using a control unit as recited in claim 1, wherein the data source is an alcohol sensor monitoring the driver, said receiving data further comprising receiving data indicating that the blood alcohol level of the driver is above a predetermined threshold.

14. The method of using a control unit as recited in claim 13, wherein the method further comprises automatically dialing a phone number using a telephone in communication with the control unit and playing a message when the phone is answered which describes the condition of the driver, the location, speed and heading of the vehicle and the location of the safe area where the driver is heading.

15. A method of using a control unit as recited in claim 1, wherein the data source is a sensor monitoring the driver configured to detect drowsiness in the driver, said receiving data further comprising receiving data indicating that the driver is drowsy.

16. The method of using a control unit as recited in claim 15, wherein the method further comprises notifying the driver that he or she is drowsy and advising the driver to drive to a safe area and rest.

17. A method of using a control unit as recited in claim 16, further comprising querying the driver after the vehicle is parked to determine if the control unit should set an alarm to wake the driver after a predetermined period of time.

18. A method of using a control unit as recited in claim 1, wherein the data source is a sensor monitoring the vehicle, said receiving data further comprising receiving data indicating the existence of a problem with the vehicle.

19. The method of using a control unit as recited in claim 18, wherein the method further comprises notifying the driver of the existence of the problem with the vehicle.

20. A method of using a control unit as recited in claim 19, said method further comprising determining that the problem with the vehicle makes the vehicle unsafe to drive; determining that the vehicle is in a location in which it is safe for the vehicle to pull over; and wherein said notifying further comprises notifying the driver that the vehicle is not safe to drive and to pull over.

21. A method of using a control unit as recited in claim 19, said method further comprising determining that the problem with the vehicle makes the vehicle unsafe to drive; determining that the vehicle is not in a location in which it is safe for the vehicle to pull over; and wherein said notifying further comprises notifying the driver that the vehicle is not safe to drive and to pull over as soon as possible.

22. A method of using a control unit to provide a vehicle driver with routing instructions to a safe area when the existence of an unsafe condition is detected, the method comprising:
receiving data indicating the existence of the unsafe condition from a data source in communication with the control unit;
notifying the vehicle driver through the use of an output device in communication with the control unit of the existence of the unsafe condition;
automatically querying the driver in response to the existence of the unsafe condition to determine if the driver would like routing instructions to the safe area;
receiving an input from the driver through the use of an input device in communication with the control unit requesting routing instructions to the safe area;
selecting the safe area and generating routing instructions to the safe area in response to said receiving an input indicating the request for routing instructions; and
communicating the routing instructions to the driver.

23. A method of using a control unit as recited in claim 22, said receiving data further comprising receiving data indicating data entry by the driver, the method further comprising determining that an unsafe condition exists when data entry continues in excess of a predetermined amount of time.

24. A method of using a control unit as recited in claim 23, said notifying the driver further comprising querying the driver to determine if the data entry task should be paused, the method further comprising pausing the data entry task in response to a pause request.

25. A method of using a control unit as recited in claim 22, said receiving data further comprising receiving data indicating data entry by the driver, the method further comprising determining that an unsafe condition exists when the amount of data entered exceeds a predetermined amount.

26. A method of using a control unit as recited in claim 25, said notifying the driver further comprising querying the driver to determine if the data entry task should be paused, the method further comprising pausing the data entry task in response to a pause request.

27. A method of using a control unit as recited in claim 22, said receiving data further comprising receiving data indicating the driver is operating a device that could pose a driving hazard, the method further comprising querying the driver to determine if the operation of the device should be paused, the method further comprising pausing the operation of the device in response to a pause request.

28. A method of using a control unit as recited in claim 27, said receiving data further comprising receiving data indicating that the device is a cell phone, said querying the driver further comprising querying the driver to determine if the cell phone activity should be paused, the method further comprising pausing the cell phone activity in response to a pause request.

29. A method of using a control unit as recited in claim 22, said receiving data further comprising receiving data indicating the occurrence of a task of changing a vehicle setting, the method further comprising querying the driver to determine if the changing a vehicle setting task should be paused, the method further comprising pausing the changing a vehicle setting task in response to a pause request.

30. A method of using a control unit as recited in claim 22, wherein the data source is a source of weather information, said receiving data further comprising receiving data indicating the existence of a dangerous weather condition and said notifying comprising notifying the driver of the weather condition.

31. A method of using a control unit as recited in claim 22, wherein the data source is a source of traffic information, said receiving data further comprising receiving traffic data indicating the existence of traffic congestion, said notifying comprising notifying the driver of the traffic congestion.

32. A method of using a control unit as recited in claim 31, wherein the source of traffic information is a service provider.

33. A method of using a control unit as recited in claim 31, the method further comprising recalculating the driving time to the selected safe area in response to receiving the traffic data as the vehicle travels to the selected safe area and automatically calculating routing instructions to a second safe area if the travel time to the selected safe area is longer than a predetermined time.

34. A control system configured to provide a vehicle driver with routing instructions to a safe area when data is received from a data source indicating the existence of an unsafe condition, said control unit comprising:
a control unit comprising a processing unit and a data storage unit that is in communication with said processing unit, said data storage unit being configured to have a collection of data resident therein;
an output device in communication with said control unit and capable of communicating with the driver;
an input device in communication with said control unit that is configured to receive an input from the driver and to send data to said control unit in response to the driver input; and
an input port in communication with said control unit and with the data source, said input port being configured to send data received from the data source to said control unit;
wherein said control unit is programmed to:
receive data from the data source indicating the existence of an unsafe condition;
calculate routing instructions to the safe location; and
communicate the routing instructions to the driver using the output device.

35. The control system as recited in claim 34, wherein said control unit is mounted in a vehicle.

36. The control system as recited in claim 34, wherein said control unit is a portable device.

37. The control system as recited in claim 34, wherein said control unit is in communication with a remote service provider.

38. The control system as recited in claim 34, wherein said control unit is further programmed to select from a collection of data resident in said data storage unit a safe area that can be reached within a predetermined period of time.

39. The control system as recited in claim 34, wherein said control unit is further programmed to select from a collection of data resident in said data storage unit the nearest safe area.

40. The control system as recited in claim 34, wherein said navigation control unit is further programmed to:
select from a collection of data resident in said data storage unit a safe area that will require more than a predetermined amount of time to reach;
calculate the estimated amount of time required to reach the safe area; and
communicate to the driver through the use of the output device the estimated amount of time required to reach the safe area.

41. The control system as recited in claim 34, wherein said navigation control unit is further programmed to:
determine the location, speed and heading of the vehicle;
determine turn-by-turn directions to the safe area; and
determine that the driver has at least a pre-determined amount of time to make each traffic maneuver required in order to follow the turn-by-turn directions.

42. The control system as recited in claim 34, wherein said output device further comprises a display unit and wherein said control unit is further programmed to communicate the routing instructions to the driver through the use of the display unit.

43. The control system as recited in claim 42, wherein said control unit is further programmed to communicate the routing instructions to the driver through the use of the display unit by displaying a graphical image on the display unit which indicates the location of the vehicle, the destination safe area, and the route to the safe area.

44. The control system as recited in claim 34, wherein said output device further comprises an audio unit and wherein said navigation control unit is further programmed to communicate the routing instructions to the driver audibly.

45. The control unit as recited in claim 34, wherein said navigation control unit is further programmed to:
automatically query the driver to determine if the driver wants routing instructions to a safe area; and
calculate routing instructions to the safe location after receiving data indicating the driver want to receive routing instructions.

46. The control unit as recited in claim 34, wherein said navigation control unit is further programmed to:
select a safe area from a collection of data resident in said data storage unit in which the safe areas are in categories by type; and
select one or more categories to search to locate a suitable safe area.

47. The control system as recited in claim 34, further comprising a driver sensor in communication with said input port, said driver sensor being configured to receive data about the driver and operable as a data source indicating the existence of an unsafe condition arising from the driver and wherein said control unit is further programmed to receive data indicating the existence of an unsafe condition arising from the driver.

48. The control system as recited in claim 34, wherein said driver sensor is an alcohol sensor monitoring the driver and wherein said control unit is further programmed to:
receive data from the alcohol sensor indicating that the blood alcohol level of the driver is above a predetermined threshold;
communicate a message to the driver notifying the driver of his condition and suggesting that the driver go to a safe area immediately.

49. The control system as recited in claim 48, wherein said control unit is further programmed to:
determine if the vehicle is in a location where the vehicle can be safely pulled over to the side of the road immediately; and
suggest that the driver pull the car over immediately.

50. The control system as recited in claim 48, wherein said driver sensor monitoring the driver is an alcohol sensor and wherein said navigation control unit is further programmed to:
receive data from the alcohol sensor indicating that the blood alcohol level of the driver is above a predetermined threshold;
dial a phone number using a telephone in communication with the navigation control unit; and
play a message when the phone is answered which describes the condition of the driver, the location, speed and heading of the vehicle and the location of the safe area where the driver is heading.

51. The control system as recited in claim 34, wherein said driver sensor monitoring the driver is configured to detect drowsiness in the driver and wherein said navigation control unit is further programmed to communicate a message to the driver through the use of the output device that the driver is drowsy and suggest that the driver go to a safe area immediately.

52. The control system as recited in claim 34, wherein said navigation control unit is further programmed to query the driver after the vehicle is parked to determine if the control unit should set an alarm to wake the driver after a predetermined amount of time.

53. The control system as recited in claim 34, further comprising a vehicle sensor monitoring the vehicle in communication with said input port and configured to receive data about the vehicle and operable as a data source indicating the existence of a problem with the vehicle and wherein said navigation control unit is further programmed to:
receive data indicating the existence of an unsafe condition of the vehicle; and
notify the driver of the problem with the vehicle.

54. The control system as recited in claim 53, wherein said navigation control unit is further programmed to automatically generate routing instructions to a vehicle repair facility.

55. The control system according to claim 54, wherein said navigation control unit is further programmed to:
determine if the problem with the vehicle is severe enough to require that the driver stop driving as soon as possible;
determine if the vehicle is in a location where the car can be pulled over immediately; and
communicate a message to the driver using said output device advising the driver to pull over immediately.

56. A method of selecting a safe area for a motor vehicle, comprising:
detecting an unsafe condition;
receiving the location of the motor vehicle;
retrieving a predetermined time;
retrieving a plurality of points of interest;
selecting at least one of the plurality of points of interest that can be reached by the vehicle within the predetermined time;
using the at least one of the plurality of points of interest as a safe area; and
automatically providing routing instructions to the safe area.

57. The method as recited in claim 56, wherein said step of receiving the location of the motor vehicle further includes receiving the speed of the motor vehicle.

58. The method as recited in claim 56, wherein said step of receiving the location of the motor vehicle further includes receiving the heading of the motor vehicle.

59. The method as recited in claim 56, wherein said step of selecting is followed by a step of checking if the selected point of interest meets a requirement associated with the unsafe condition.

60. The method as recited in claim 56, wherein said predetermined time can vary according to the type of unsafe condition.
